(19) United States
(12) Patent Application Publication
(10) Pub. No.: US 2019/0138961 A1
(43) Pub. Date: May 9, 2019

(54) SYSTEM AND METHOD FOR PROJECT MANAGEMENT USING ARTIFICIAL INTELLIGENCE

(71) Applicant: INDIDESK, S.L., Madrid (ES)

(72) Inventors: Diego Santiago, Guatemala (GT); Pablo Fortini, Madrid (ES); Jorge Mario Martinez, Guatemala (GT)

(73) Assignee: Indidesk, S.L. (fna Smart Canvas Solutions Espana, S.L.), Madrid (ES)

(21) Appl. No.: 15/806,289

(22) Filed: Nov. 7, 2017

(51) Int. Cl. G06Q 10/06; G06Q 10/10; G06F 15/18; G06N 3/02; G06N 5/04; G06F 17/18; G06T 11/20

(52) U.S. Cl. CPC G06Q 10/06313; G06Q 10/103; G06Q 10/06314; G06Q 10/06312; G06T 11/206; G06F 15/18; G06N 3/02; G06N 5/04; G06F 17/18; G06Q 10/063118

(57) ABSTRACT

A method and system can include a program management system configured to receive inputs for variables for a digital project which include project types, resources, distribution platforms, and scope of the digital project, and to generate at least the timeline and the cost based on the received inputs for variables for the digital project, and receive a modification of at least one of the variables or receive a modification of the estimated timeline or the cost and dynamically modify the timeline or cost in response to receiving the modification of at least one of the variables or dynamically modify at least one of the variables in response to receiving the modification to the timeline or the cost. The method and system can further present timeline and the cost for the digital project after receiving the modification of at least one of the variables.

### FIELD OF THE DISCLOSURE

The present disclosure generally relates to systems and methods for providing project management, and more particularly relates to an innovative system and related method to manage projects using an artificial intelligence engine/agent by incorporating specific methodologies to improve the accuracy of estimating at least project costs, timelines, and resources at the outset of a project and during the current life of a project.

### BACKGROUND

In artificial intelligence, there are several components that make a machine knowledgeable to be able to respond to user requests as data. A first component is understanding the context and the knowledge base of that data. Once the machine learns and understands the data and creates context and insights from a collection of documents and data, it can generate information intelligently on that data set. Most Artificial Intelligence (AI) agents, use machine learning algorithms to detect “signals” or patterns in the data. Users can load their data and document collection into the service, train a machine learning model based on known relevant results, then leverage this model to provide improved results (generally known as “Retrieve and Rank” to their end users based on their question or query (Ex: an experienced technician can quickly find solutions from dense product manuals).

The second component to providing relevant responses and meaningful dialog with the user is through structured questions. In this model, a structured question and answer model is created that will take the user thru a set of questions to a final decision point to provide the best possible personalized solution to the user. Machine learning enables computing devices to make inferences from data sets (the larger the better), and to continually adjust those inferences to be increasingly accurate based on new data.

### BRIEF DESCRIPTION OF DRAWINGS

FIG. 1 is a flow chart of a method of program management in accordance with an embodiment;

FIGS. 2A-2F is a flow chart using the method of FIG. 1 in accordance with an embodiment;

FIGS. 3A-3S is a series of user interface screen shots in accordance with an embodiment;

FIG. 4A is a screen shot of a user interface of a dashboard in accordance with an embodiment;

FIG. 4B is a screen shot of a task listing in accordance with an embodiment;

FIG. 4C is a screen shot of a milestone listing in accordance with an embodiment;

FIG. 4D is a screen shot of a Gantt chart in accordance with an embodiment;

FIG. 4E is a screen shot of a team member listing in accordance with an embodiment;

FIG. 5 is a screen shot of a preview and feedback screen illustrating a hotspot in accordance with an embodiment;

FIG. 6 illustrates a system for project management in accordance with an embodiment;

FIG. 7 illustrates another system for project management in accordance with an embodiment herein.

### DETAILED DESCRIPTION

A system or method in accordance with the embodiments can collect data that is entered by customers into a data entry form related to digital projects about to be defined or currently running in the cloud. While/during the customer is entering data for each of the requested fields (these fields are variants that use conditional logic dependent on the fields marked in previous selections). The system and method can use artificial intelligence or machine learning to perform a task that could not be performed by a human. The system, method or architecture utilizes the embodiments including commands, queries, data flows, and the like, among elements of the architecture (e.g., modules, network elements, device components, etc.) and data inputs obtained or received as well criteria used for evaluations or decisions to provided a transformative and dynamic output in real time which are operations and processes that could not be performed manually within the context of the embodiments.

Machine learning is often defined as “the field of study that gives computers the ability to learn without being explicitly programmed. Deep learning is a subclass of machine learning that focuses on applying models that allow for the learning of hierarchical concepts. Thus, machine learning and deep learning can be viewed as one way to enable some aspects of artificial intelligence in accordance with the embodiments. Deep learning can be used for both supervised and unsupervised learning. In supervised learning, models are trained using data that includes examples with inputs and outputs. The model learns to predict the outputs given the inputs. In unsupervised learning, no outputs are provided and the model instead learns to derive inferences from the data on its own. The most common type of unsupervised learning is clustering. Deep learning is closely associated with deep neural networks (DNNs) which can also be used in the embodiments. DNN can utilize inference engines to make predictions. However, unlike training models, inference often has to be performed in real time so a major focus of inference engines is minimizing latency. Similarly, inference engines are much more likely to run locally on a device so memory, processing and power limitations must be accounted for. As result, inference engines are often optimized for particular hardware. The inference engine may be directly incorporated into a larger system or may be connected via an application programming interface or API. Embodiments herein can utilize deep learning frameworks and such example frameworks can include proprietary and open source deep learning frameworks such as Tensorflow (Google), Theano, Torch/Pytorch (Facebook), CNTK (Microsoft), and MXNet (Amazon).

Further note that the embodiments can use DNN model architectures or non-DNN machine learning model architectures which can include linear regression, logistic regression, support vector machines, Markov models, graphical models and decision trees. In some embodiments, the system can use DNN architectures such as perceptrons, feedforward neural networks, convolutional neural networks, recurrent neural networks and long short term memory neural networks (LSTMs).

In some embodiments, the data displayed in each field is generated based on the type of digital project originally selected. While the user enters the data, the platform immediately stores the data for analysis and creation of variables with monetary value and time value, using a process that captures the relationship of these variables to interpret an equation, preferably in a dynamic fashion or in real time. Here is where the total amount represented in monetary terms or cost and the total sum of the average time required for each of the fields or functions selected by the user is generated.

The platform in accordance with the embodiments can have many predefined functions that can relate and manipulate the output and flow as the process progresses. The features or functions can include programming languages, levels of complexity and types of human resources necessary to generate these variables (these selections however, affect price and duration of the project). The different variables selected for each of the projects loaded onto the platform allow the system to store all the possibilities captured by each project through “automatic learning” processes, which help understand and interpret future projects, making cost and time estimates more accurate as the system “learns” and refines its models.

Using the project management tools, the cost and time estimate is validated versus the cost and real time that the project requires. The sum of similar projects will allow the system to learn from them and predict a cost or price rate as well as an accurate time-frame. This project management tool allows the estimation of specific tasks to be broken down as parts of “milestones” (work packages) or achievable goals, distributed across the projects.

When the platform learns enough to predict the different phases, milestones (goals) and tasks of a project, they are automatically deployed after completing the process of starting a project using the tools herein. This will ensure that the user experience, the moment each project is generated has automatic real-time assignments of phases, goals or milestones and specific initial tasks relevant to the type of project.

Artificial intelligence (AI) will learn not only in terms of the cost and timeline of the functions or characteristics of the projects, but will also learn from each goal or milestone. At the same time AI will learn from each task that the project manager or “human” is assigning to the type of project. This will allow the platform to recommend new and better tasks based on the inputs that different project managers have entered.

In accordance with some embodiments, an estimation tool portion of the system can collect data entered by customers into a data entry form related to other digital projects currently running in the cloud. While the customer enters data for each of the requested fields (these fields are variants that use conditional logic dependent on the fields marked in previous selections). The logic displayed in each field is generated based on the type of digital project originally selected. While the data is entered by the user, the platform immediately stores the data for analysis and creates variables validating the monetary value and duration of each project. The estimation tool will then process the relationship amongst these variables to interpret an equation and generate an estimate assigning cost, phases and a time-frame for the development of the project and the human resources required based on each of the fields or functions selected.

The embodiments further contemplate a project management tool. Once a user completes an estimation process for the development of the project and obtains a general roadmap, the user has the opportunity to manage the project with the project management tool. In some embodiments, the project management features offers a dashboard, tasks, milestones, Gantt diagrams, team members, file sharing, preview and feedback, conversations with your team members, notifications, invoices and payments. These functions of the platform are designed for the entire project development process that include the stages for start, planning, execution, monitoring and control and closure.

The “preview and feedback” function offers the user to generate hotspots in each of the screens generated. Generating a hotspot involves selecting an area of a screen and making a real-time annotation that requests a change or provides feedback. This change or feedback is recorded by artificial intelligence. If necessary, the project manager will assign the requested change as a new task to a resource (team member). Here the project manager will decide whether or not charging the change is necessary.

Hotspots also serve the purpose of explaining specific functions in a simple and visual way. It is a very useful tool that can be used between the team and the client. In addition, this feature allows you to streamline change management within a project and documents these changes in real time and readjusts estimated delivery times if necessary.

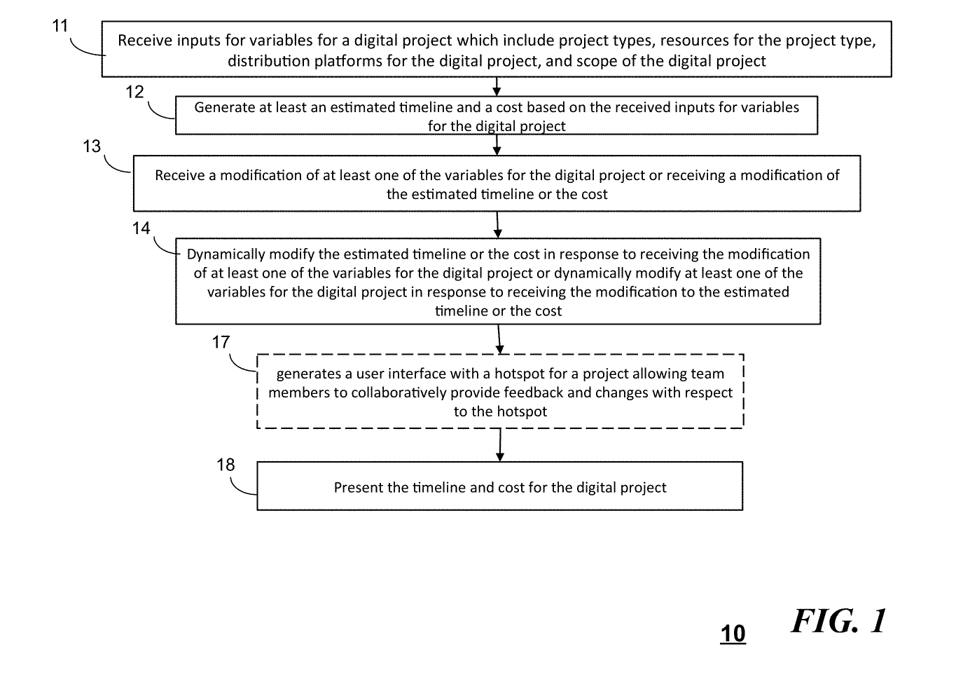

Referring to FIG. 1, a flow chart is shown illustrating a method 10 (or system) in accordance with the embodiments. In some embodiments, the method 10 can begin with a step 11 of receiving inputs for variables for a digital project which include project types, resources for the project type, distribution platforms for the digital project, and scope of the digital project. Next, the method at step 12 can generate at least an estimated timeline and a cost based on the received inputs for variables for the digital project and further receive at step 13 a modification of at least one of the variables for the digital project or receive a modification of the estimated timeline or the cost. At step 14, the method can dynamically modify the estimated timeline or the cost in response to receiving the modification of at least one of the variables for the digital project or dynamically modify at least one of the variables for the digital project in response to receiving the modification to the estimated timeline or the cost. Optionally, the method can also generate a user interface or user interfaces at step 17 with one or more hotspots for a project to allow team members to collaboratively provide feedback and changes with respect to the data associated with the hotspot that is highlighted. The method can also present a timeline and cost for the digital project at step 18 which can be manipulated dynamically or in real time as various parameters are modified at the start of a digital project or during the course of a digital project.

In some embodiments, the project types can include one or more of a project expectation among a conceptualization, a prototype, a minimum viable product or a public first release, or a mobile application or a website. In some embodiments, the distribution platforms can include one or more phone operating systems, one or more tablet operating systems, or one or more computer operating systems. In some embodiments, the scope of the digital project can include one or more of a predominant application type, a concept category, an expected traffic level, an amount of users, a geographical region. In some embodiments, the scope of the digital project comprises one or more of a logo, a brand book, a terms of conditions, a privacy policy, a frequently asked questions set, or a sitemap. In some embodiments, the scope of the digital project comprises one or more of a performance level, a storage level, a security level, or a scalability level. In yet other embodiments, the scope of the digital project further comprises functionality and features selected among one or more of accept payments, push notifications, user authentication and database, maps, geolocation, GPS, or newsfeed.

In some embodiments, the resources for the project comprises experience levels comprising one or more of a junior level resource, a senior level resource, or an expert level resource. In some embodiments, the system or method can further generate a list of recommended technologies selected among development languages, frameworks, third party service integrations, security processes or storage services. In some embodiments, the system or method can generate one or more of a status of the progress of the digital project, a task list with progress status, a gantt chart, a team member list with progress status by team member, or a file list. As noted above, in some embodiments, the system or method can further selectively generates a user interface with a hotspot for a project allowing team members to collaboratively provide feedback and changes with respect to the hotspot.

In some embodiments, the system can utilize and run user responses and inputs through a (Natural Language Understanding) NLU module (which can exist as an independent module or be part of one or more of the other modules to derive the meaning of the responses or inputs before an appropriate scope or flow is assigned for a next step.

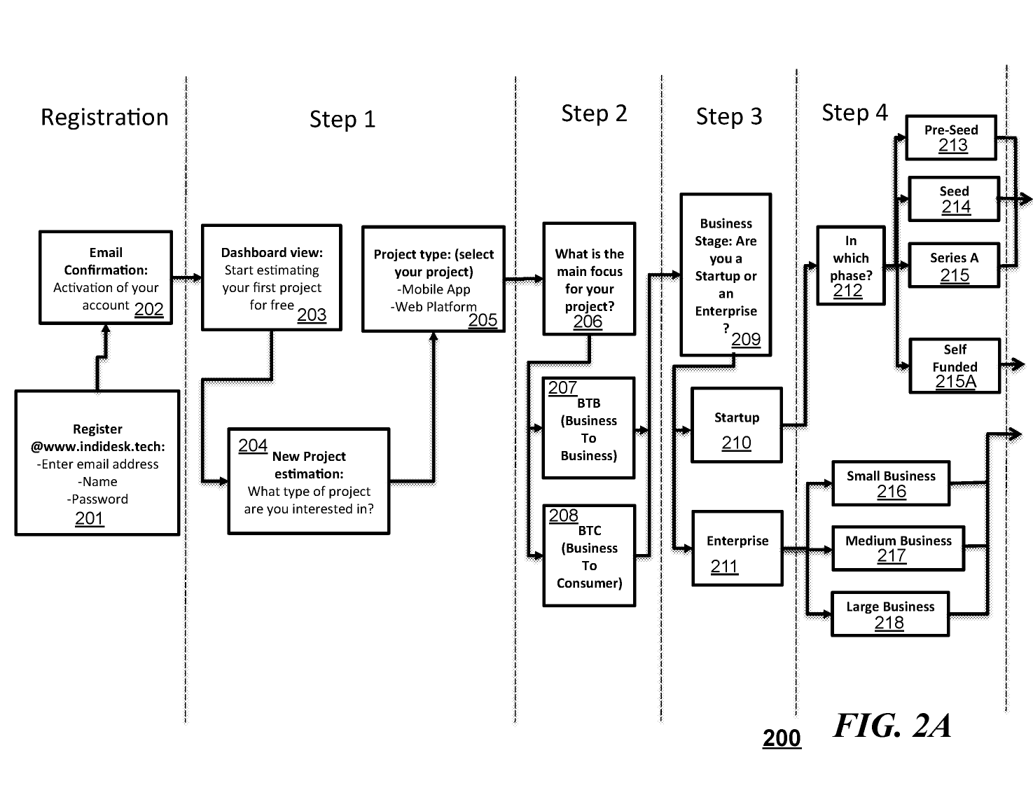

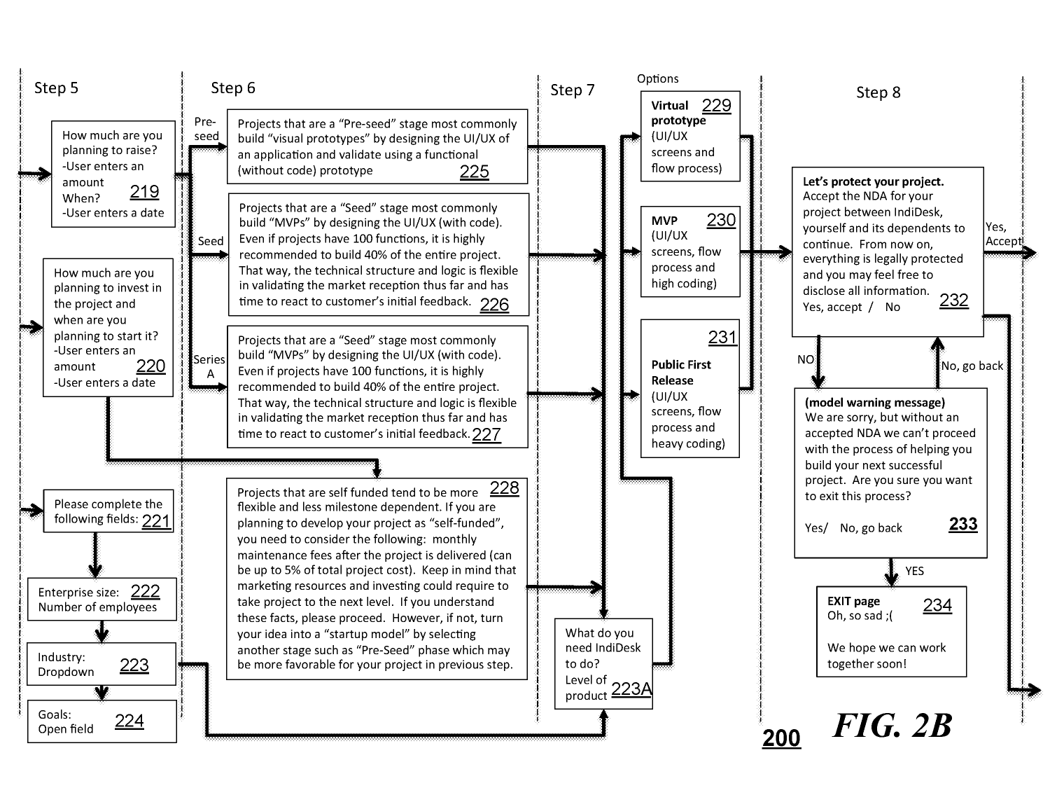

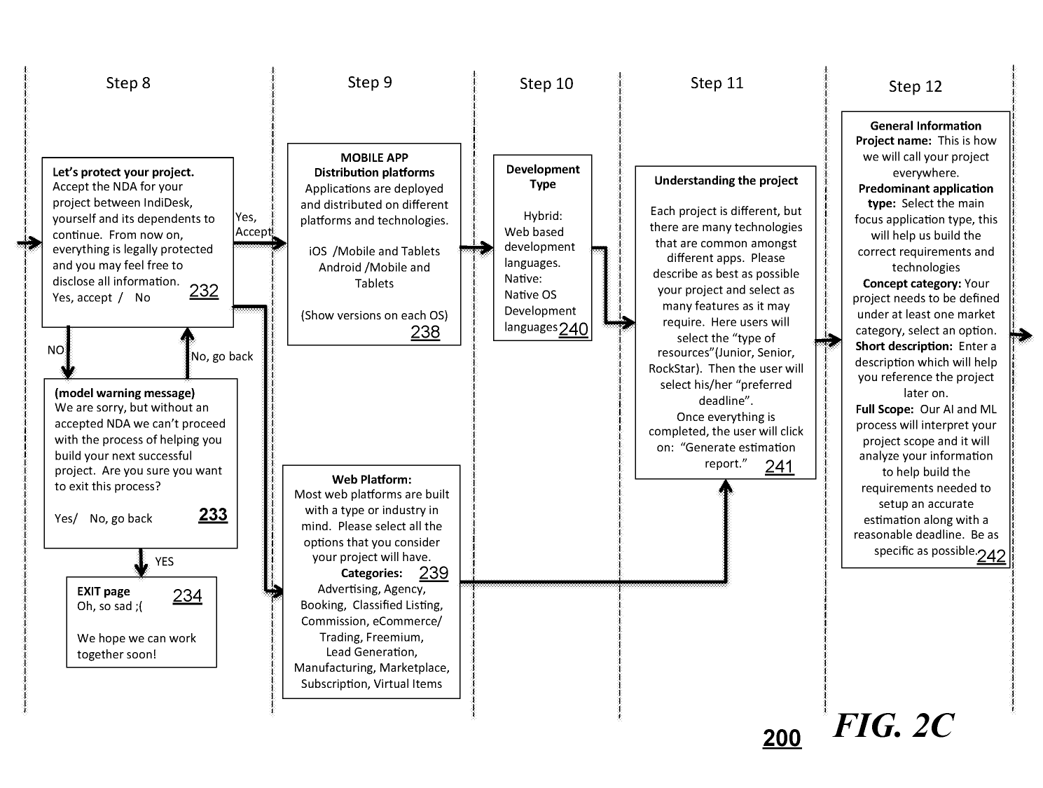

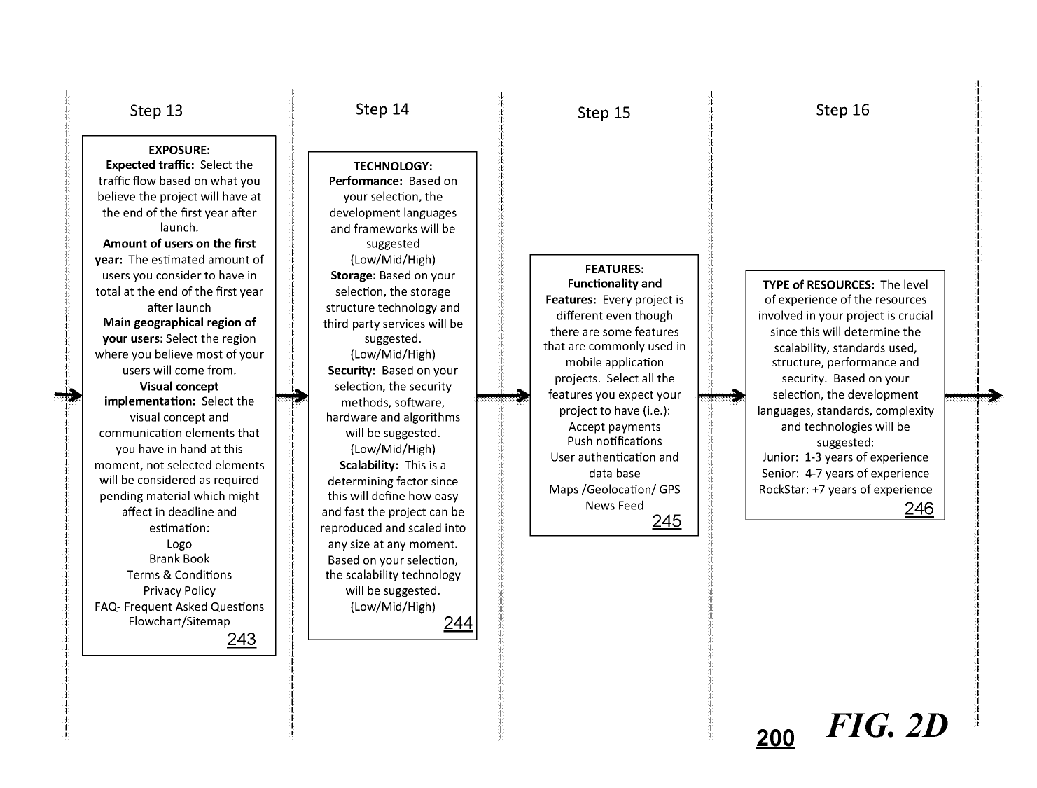

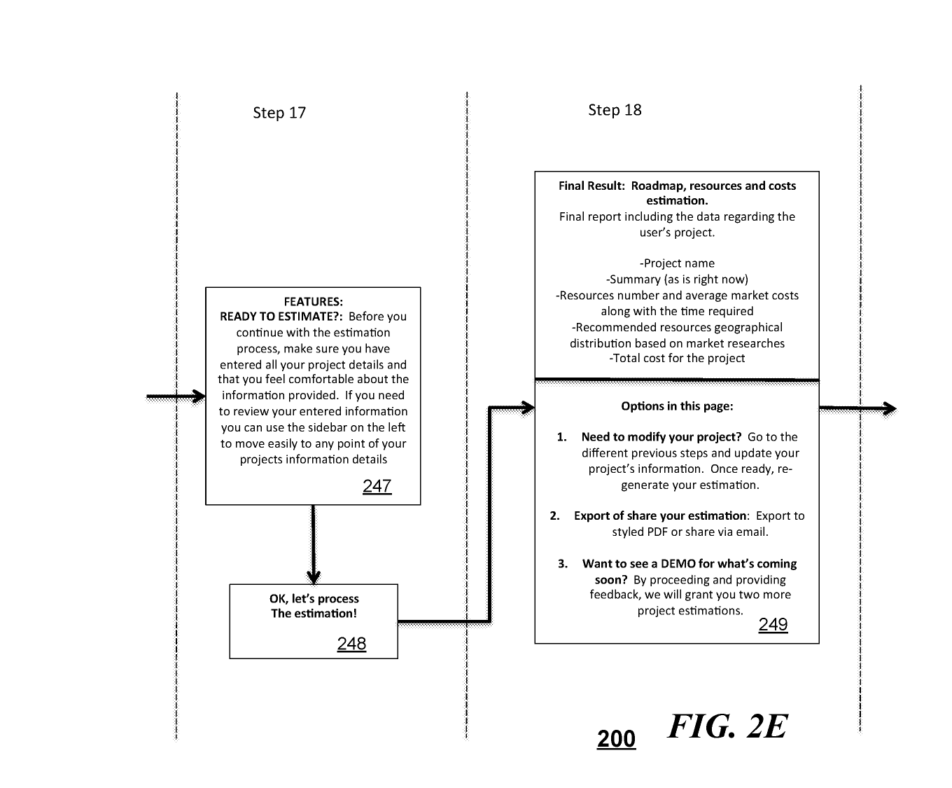

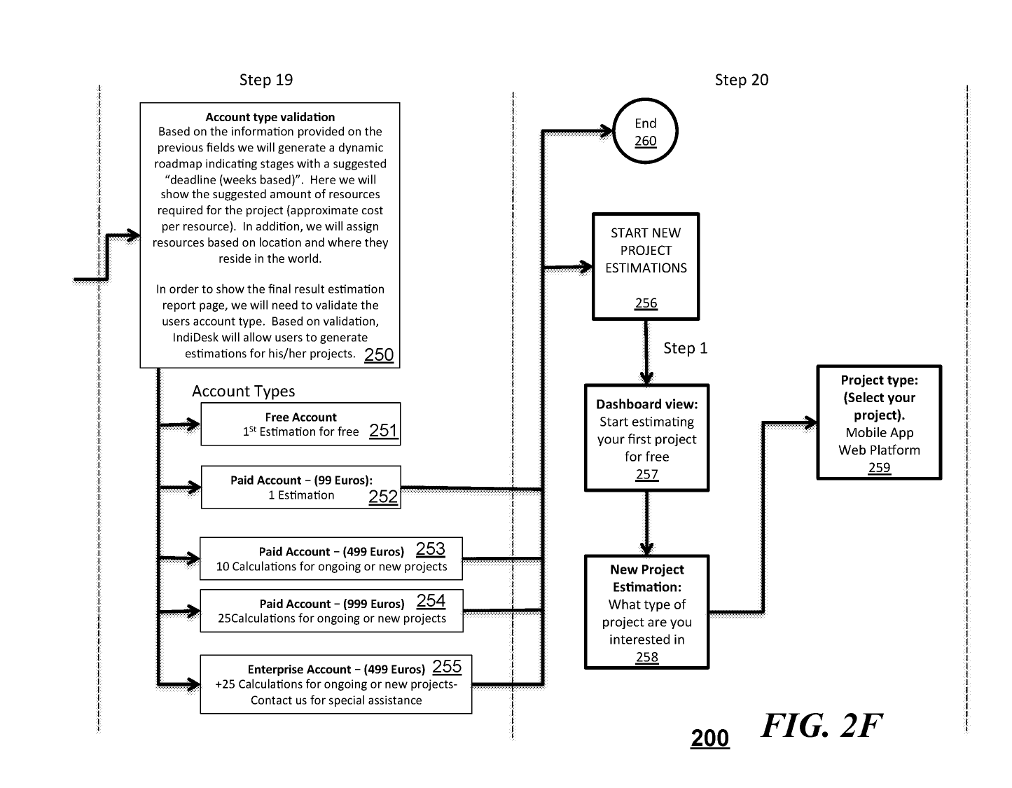

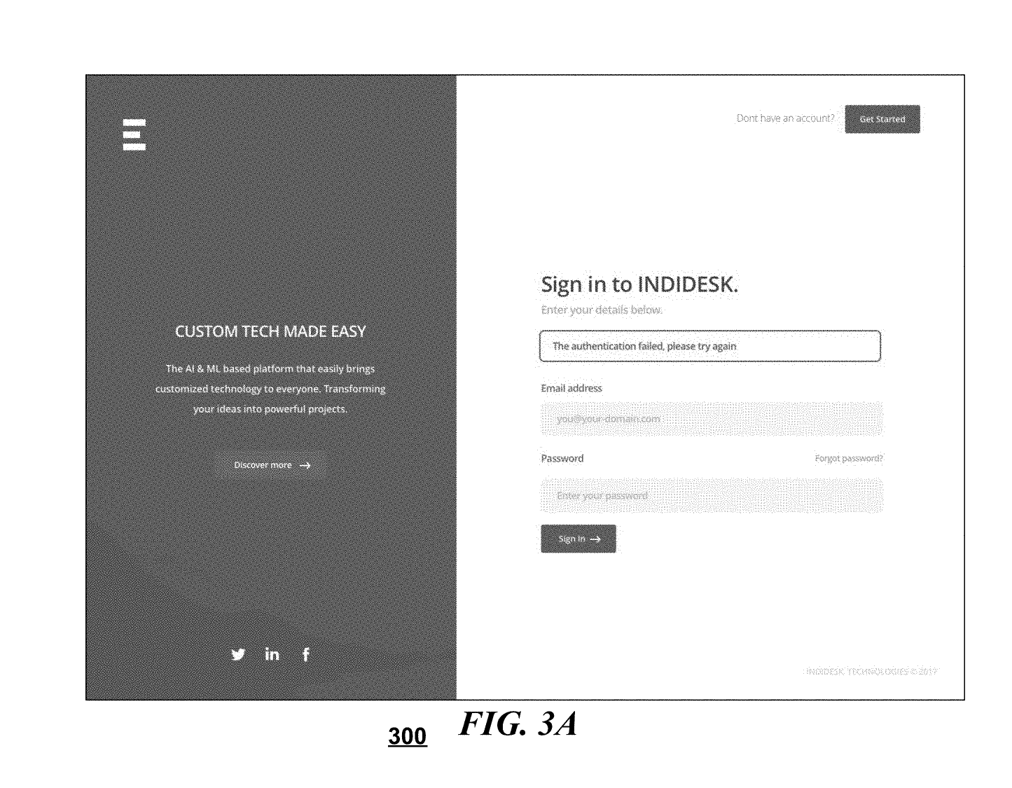

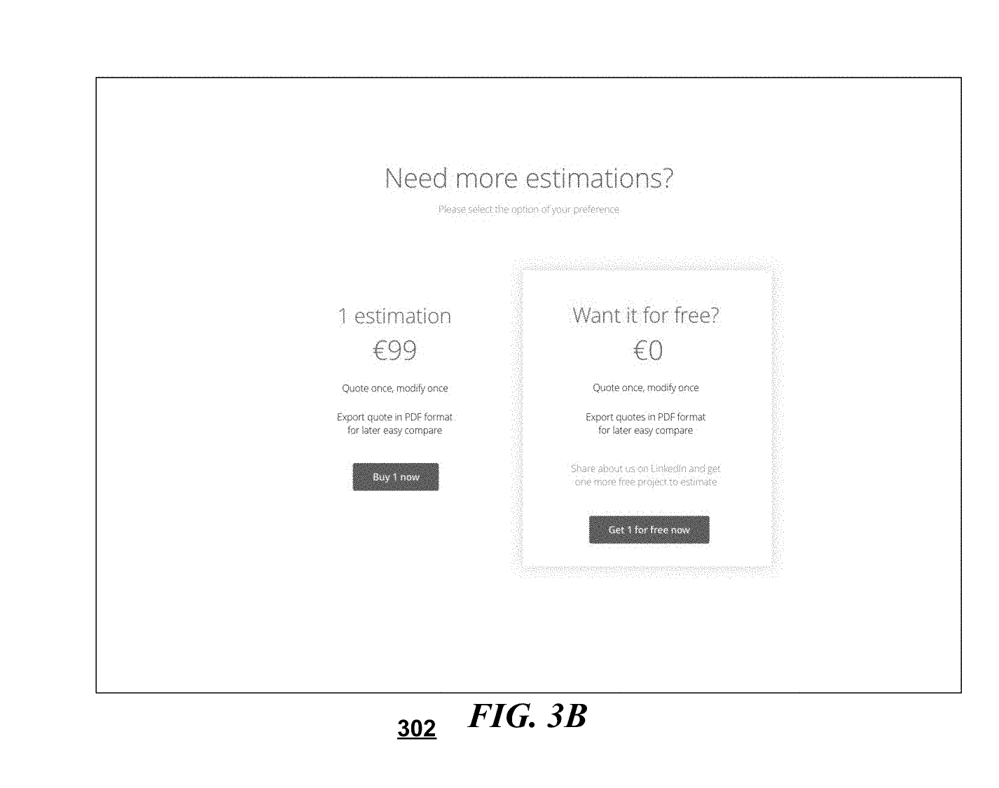

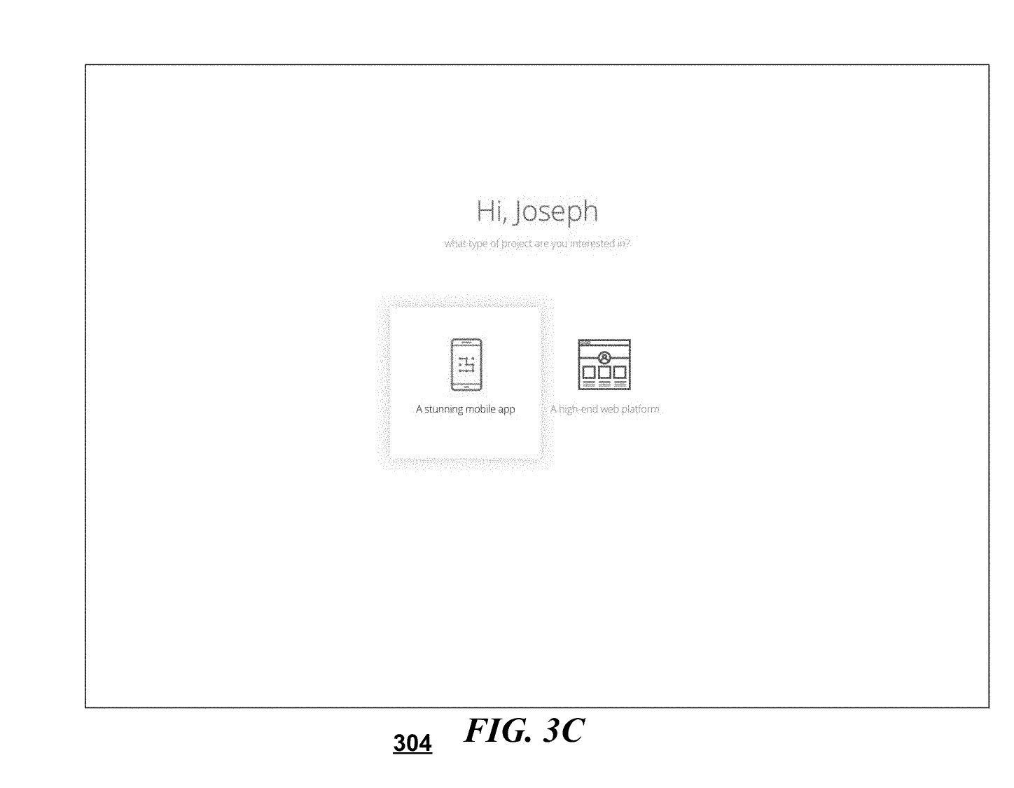

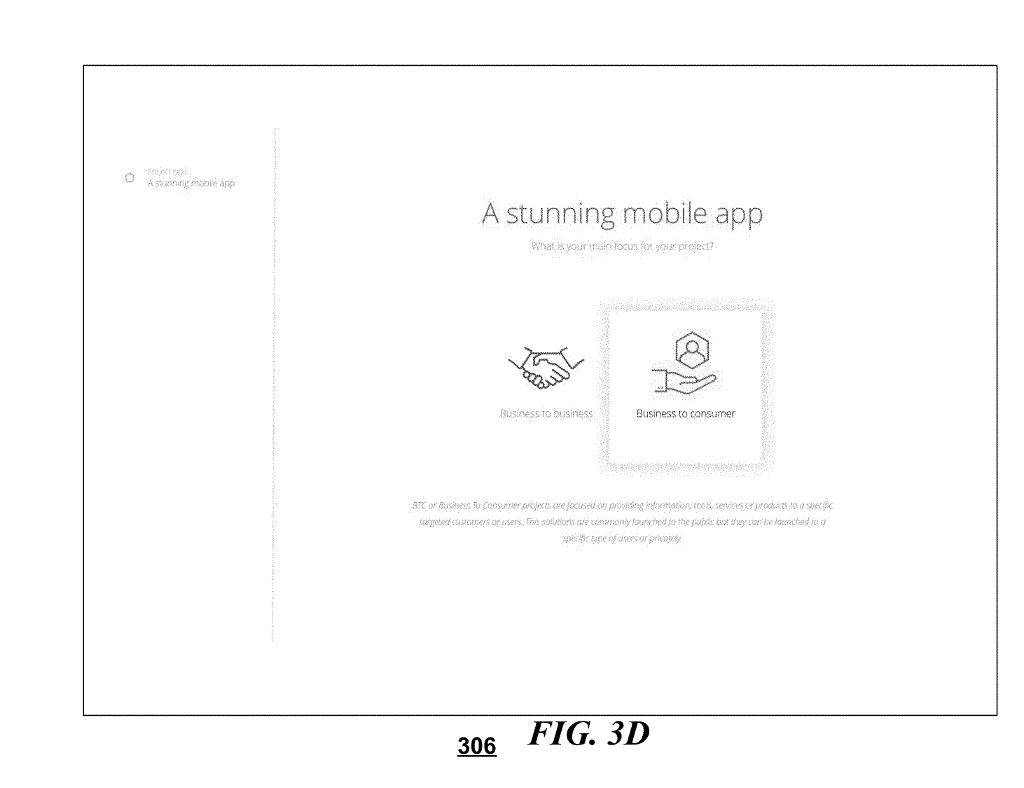

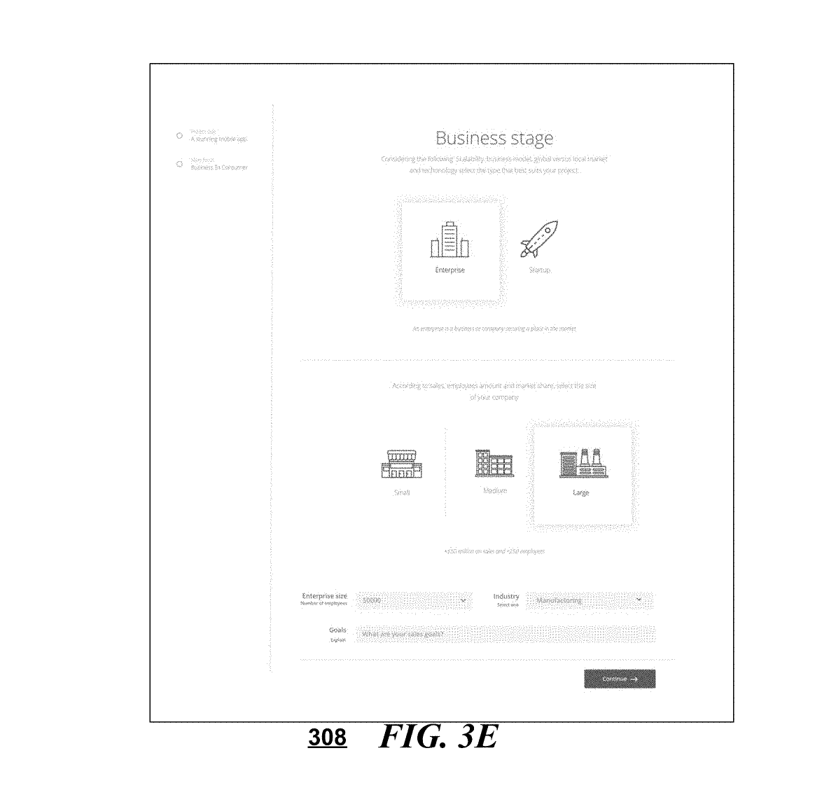

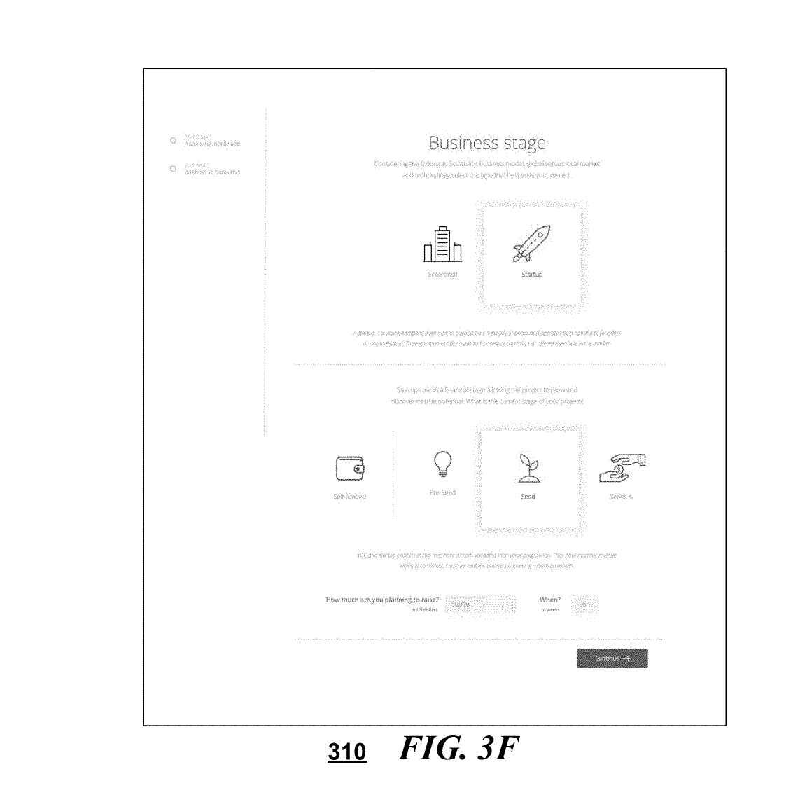

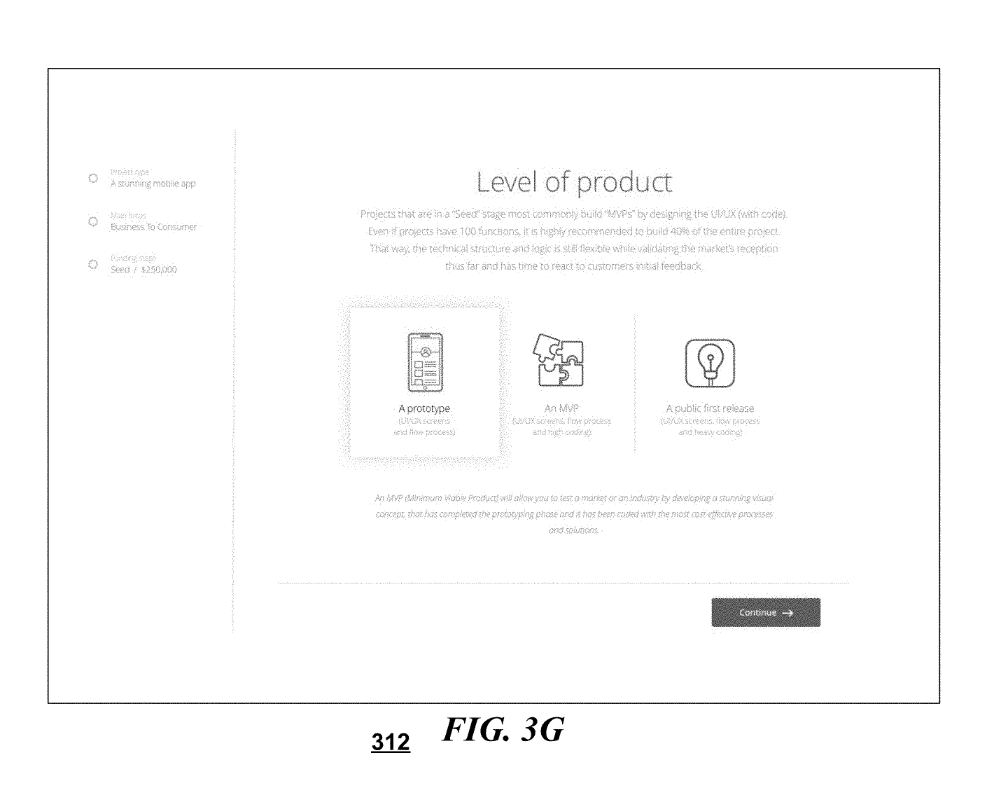

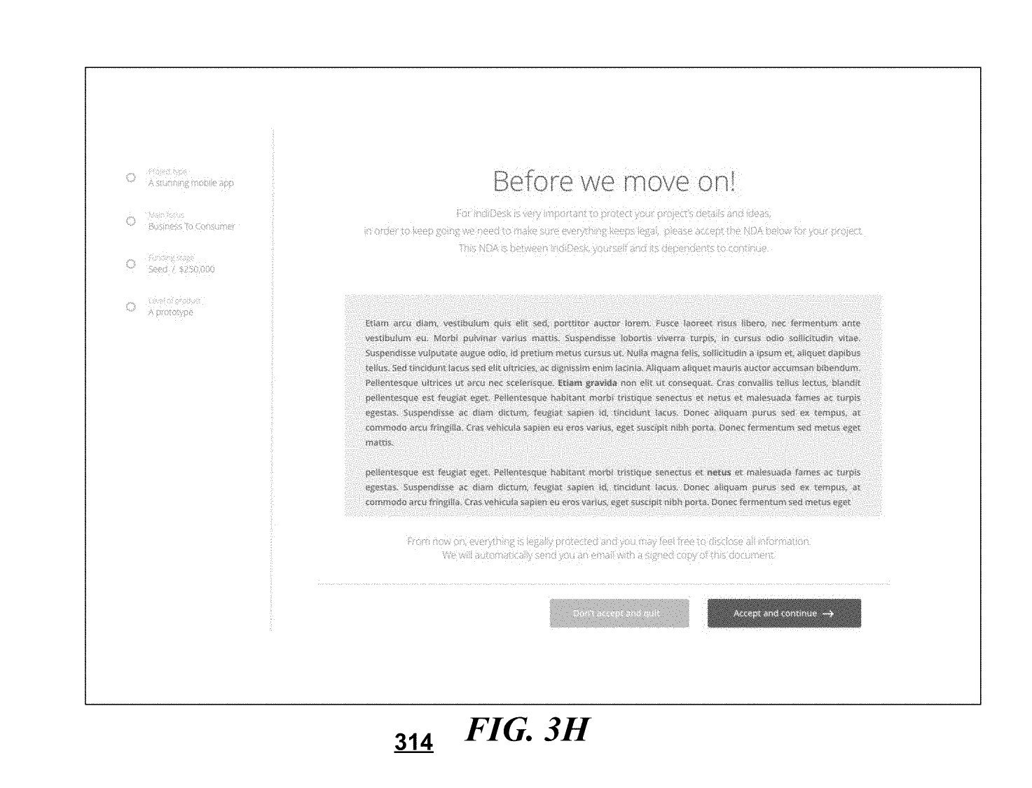

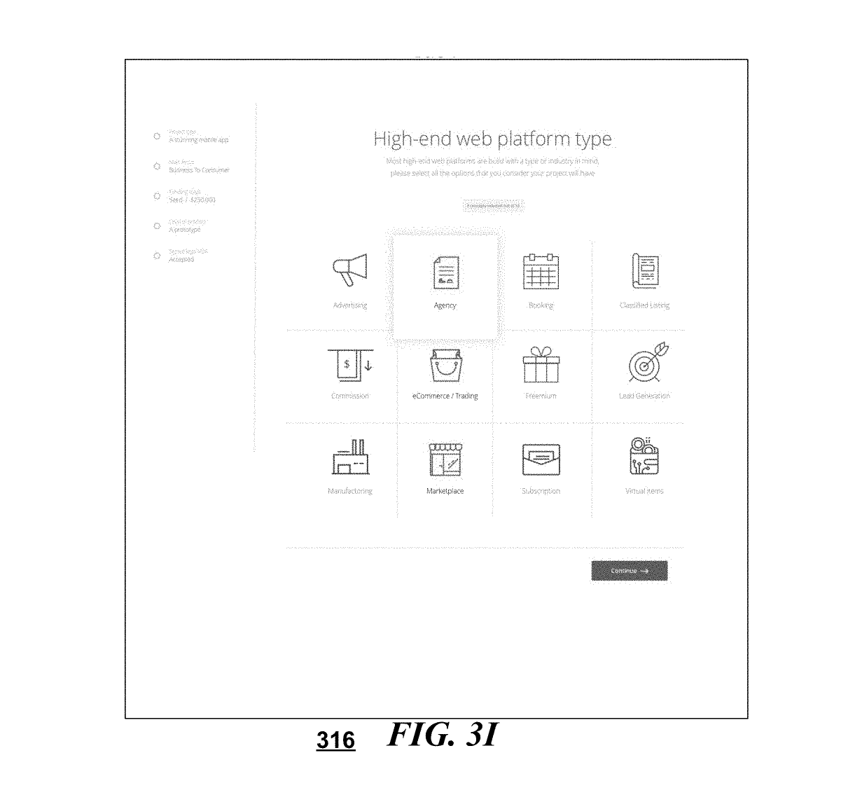

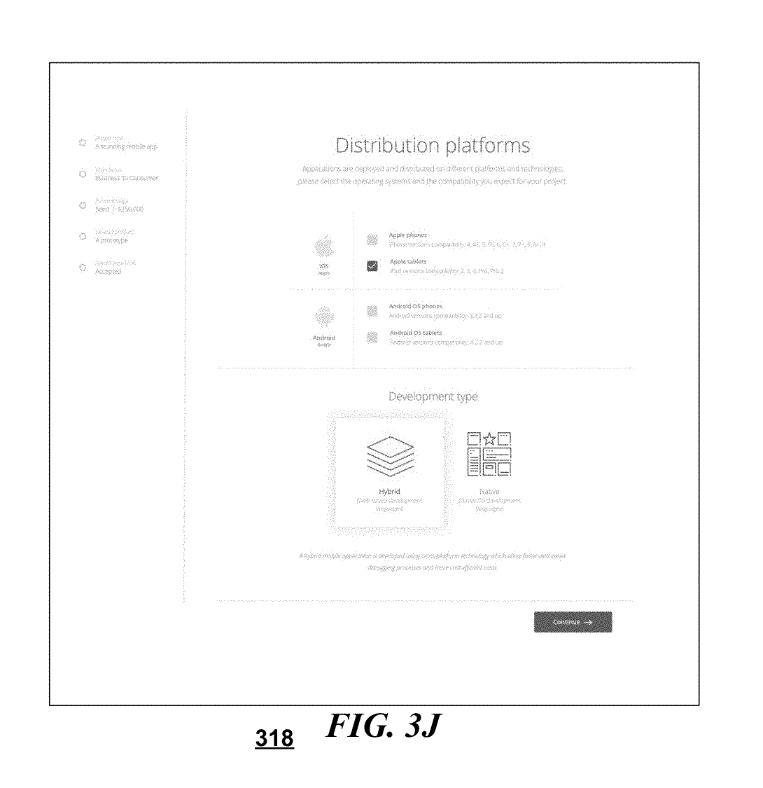

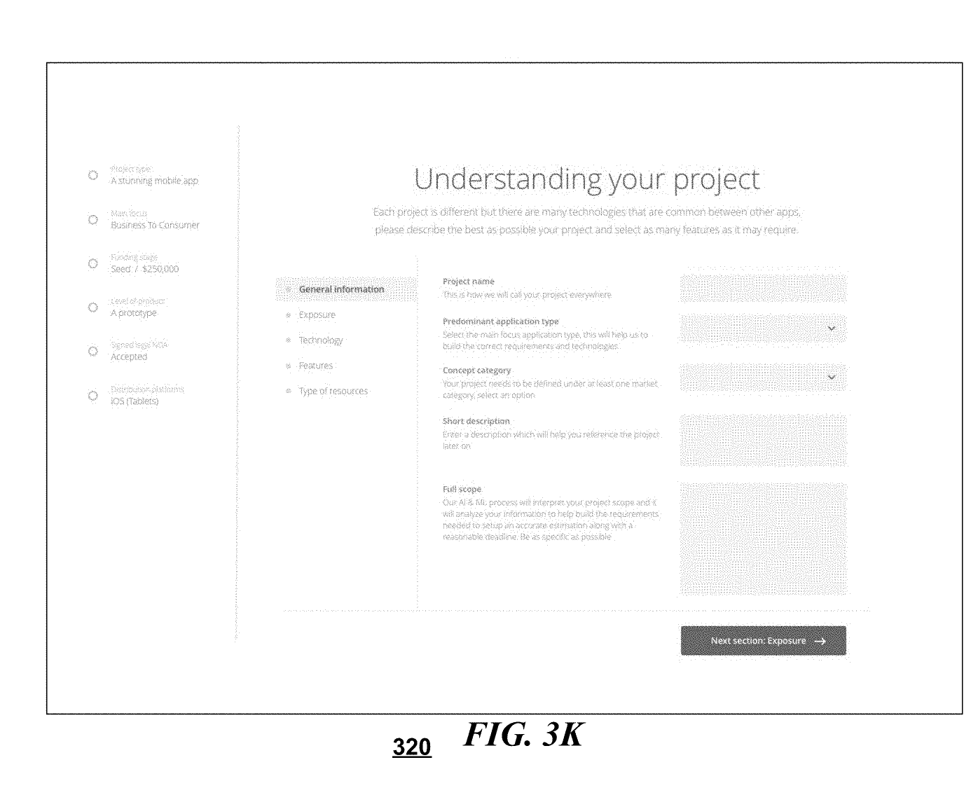

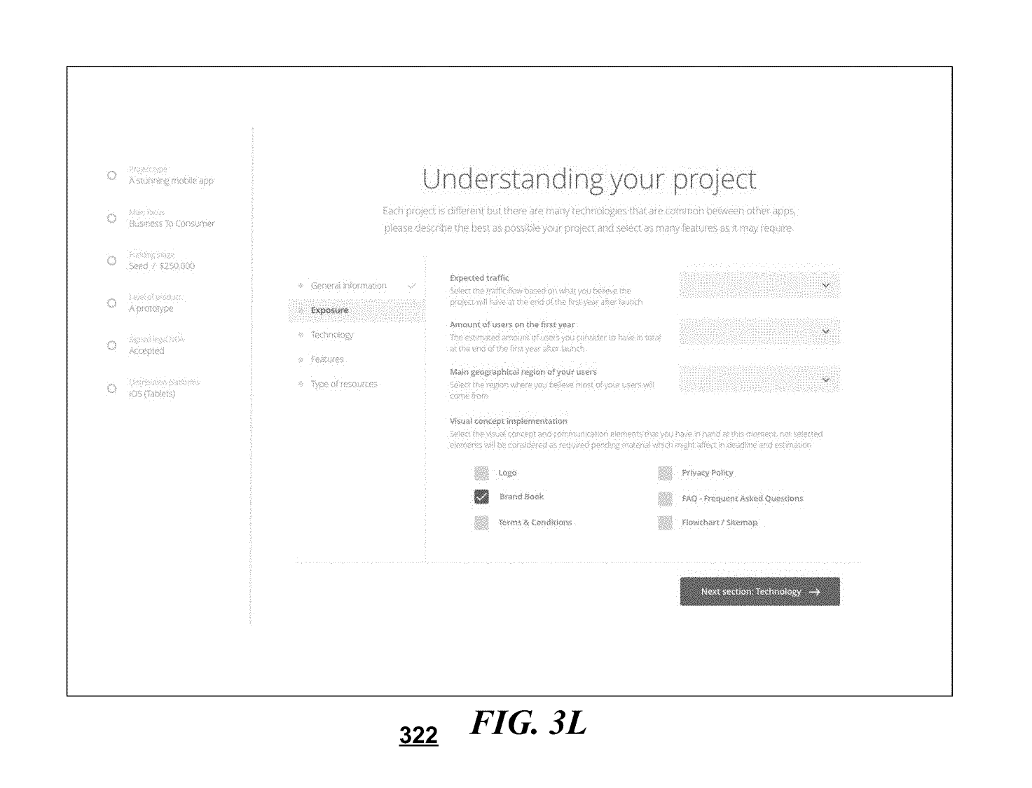

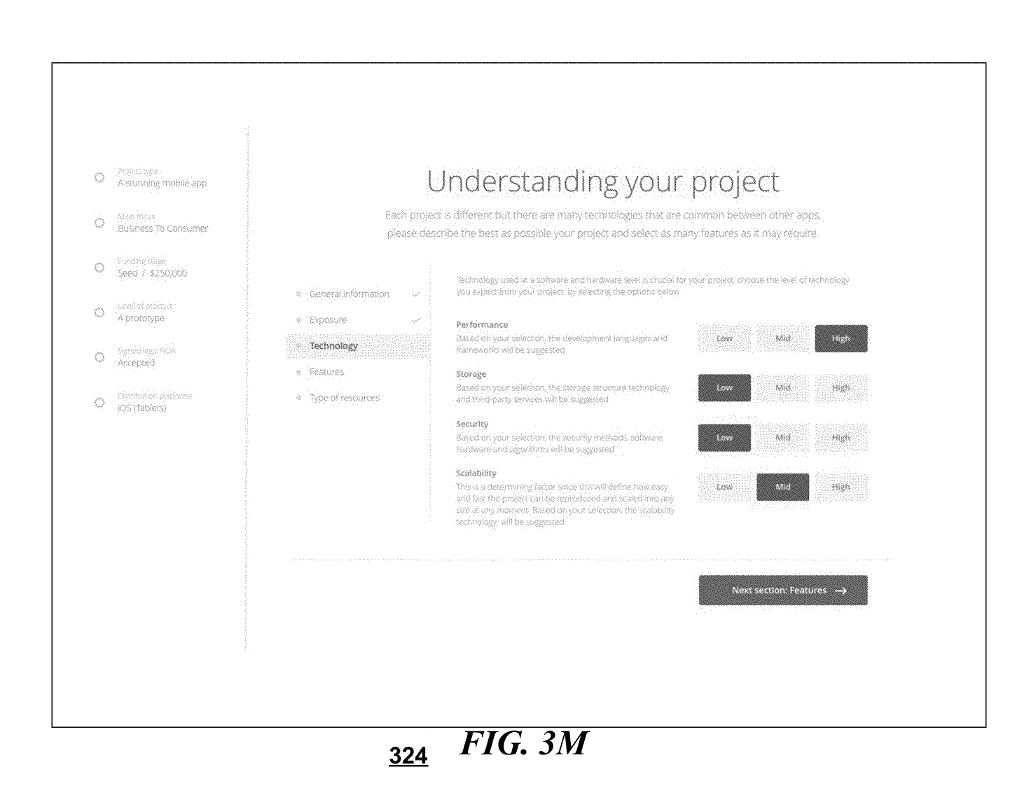

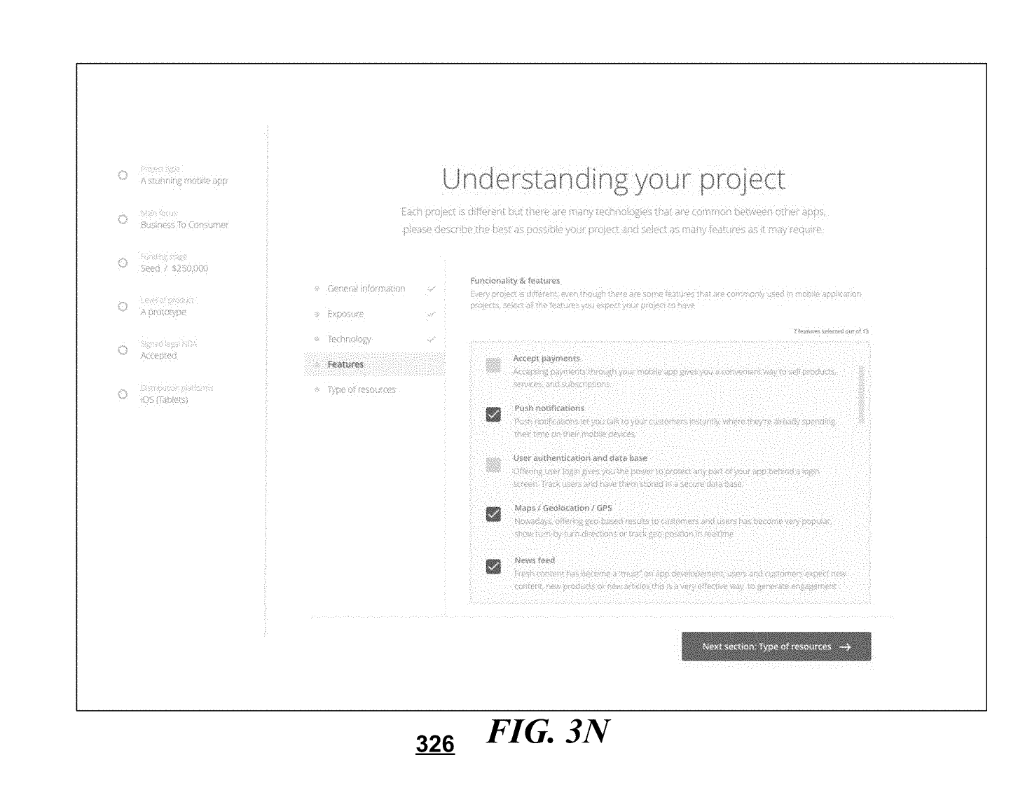

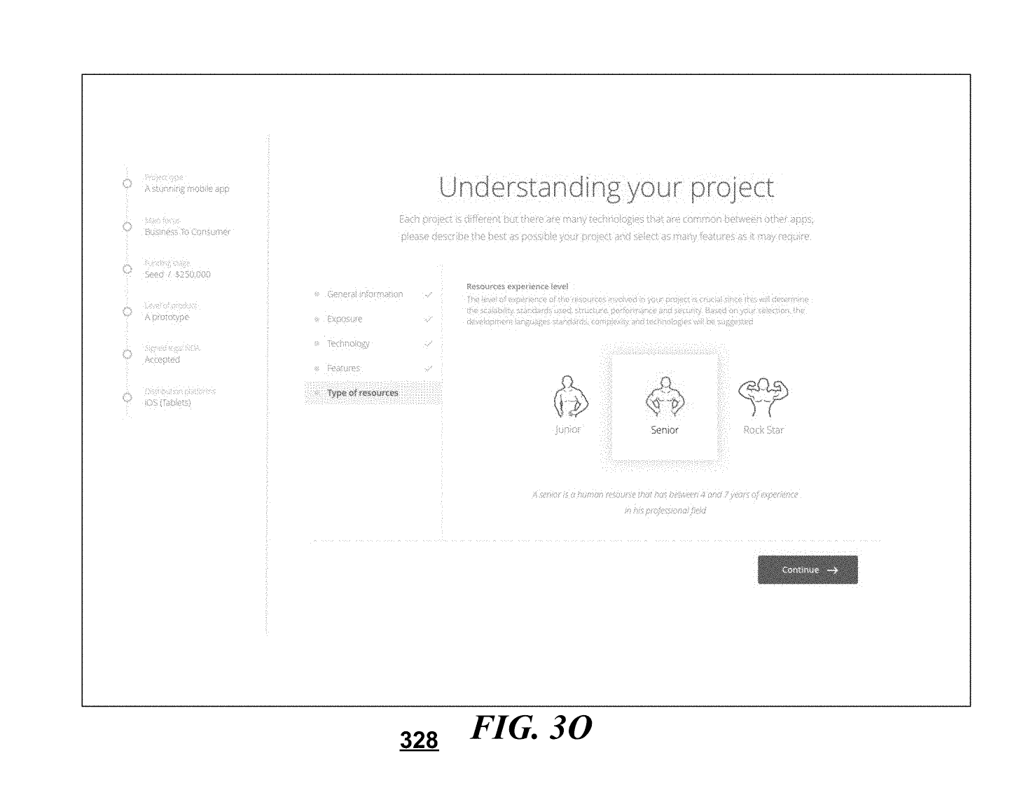

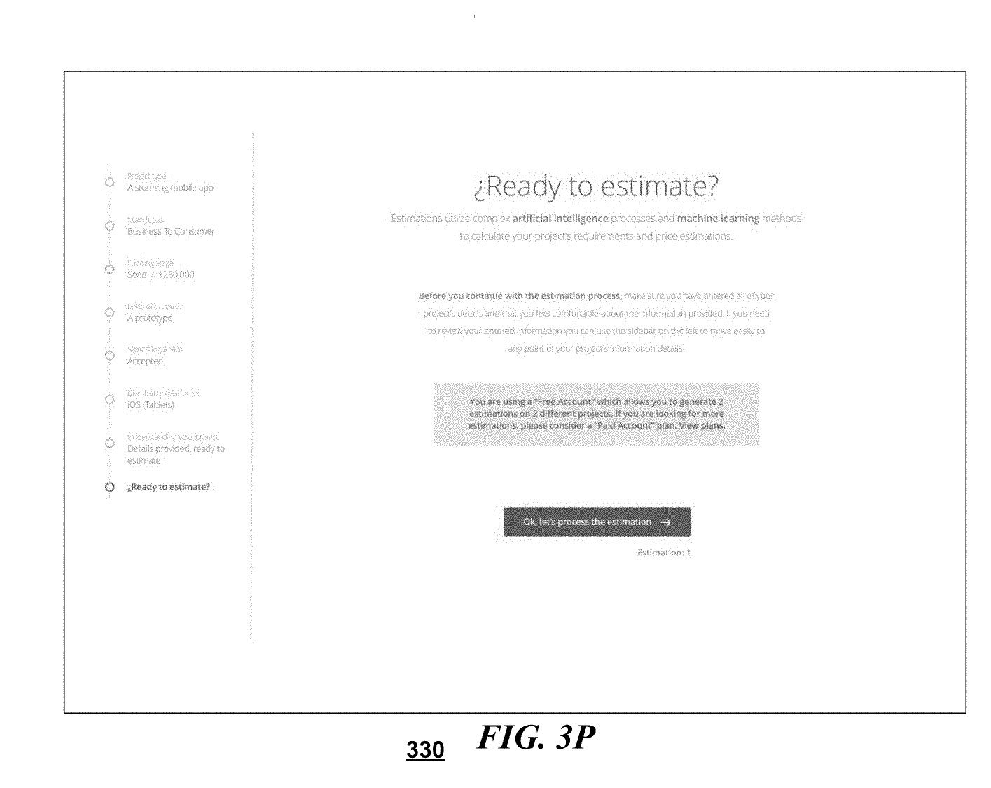

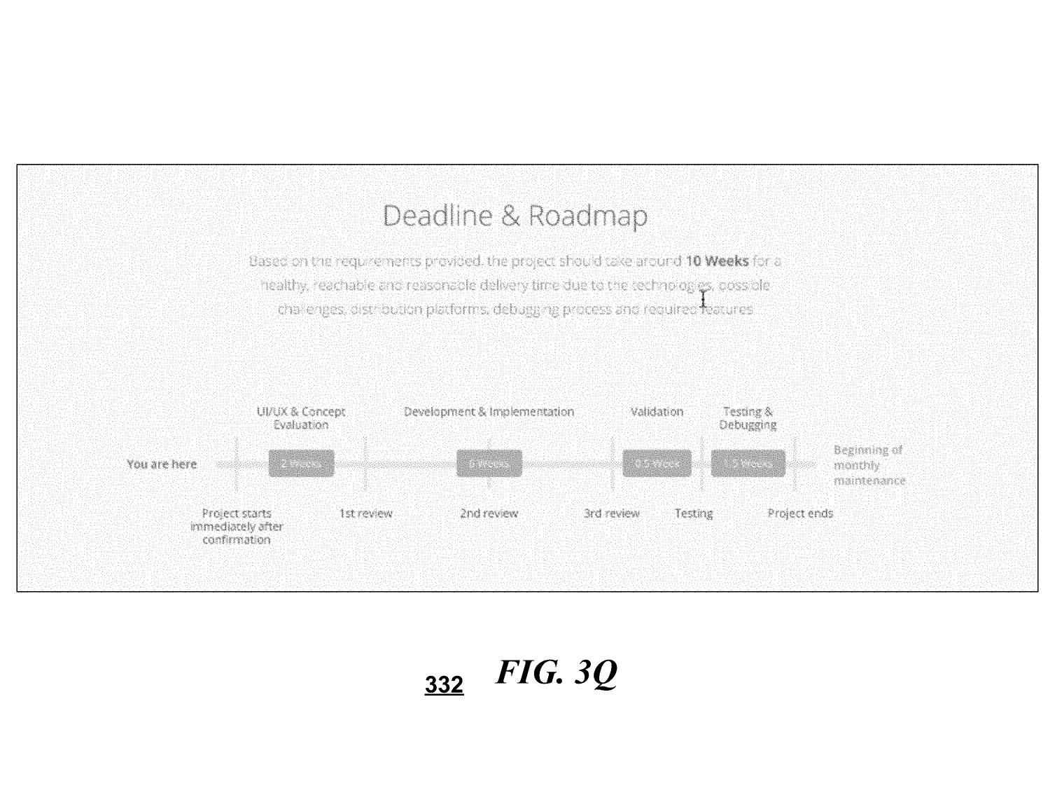

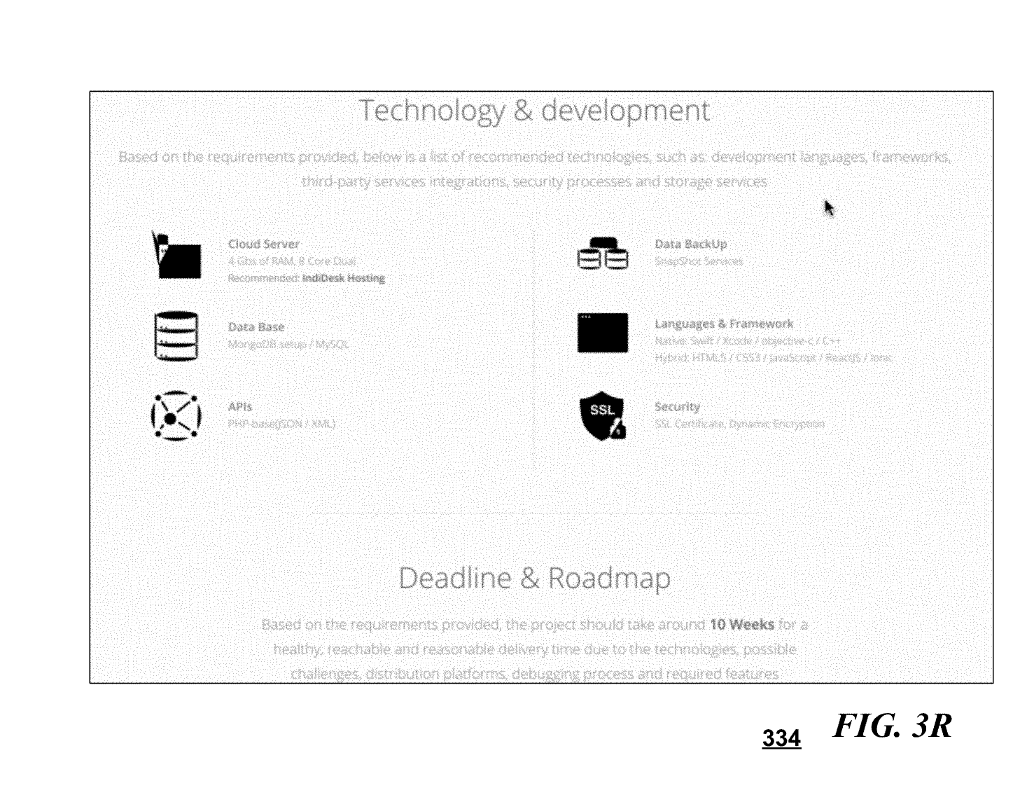

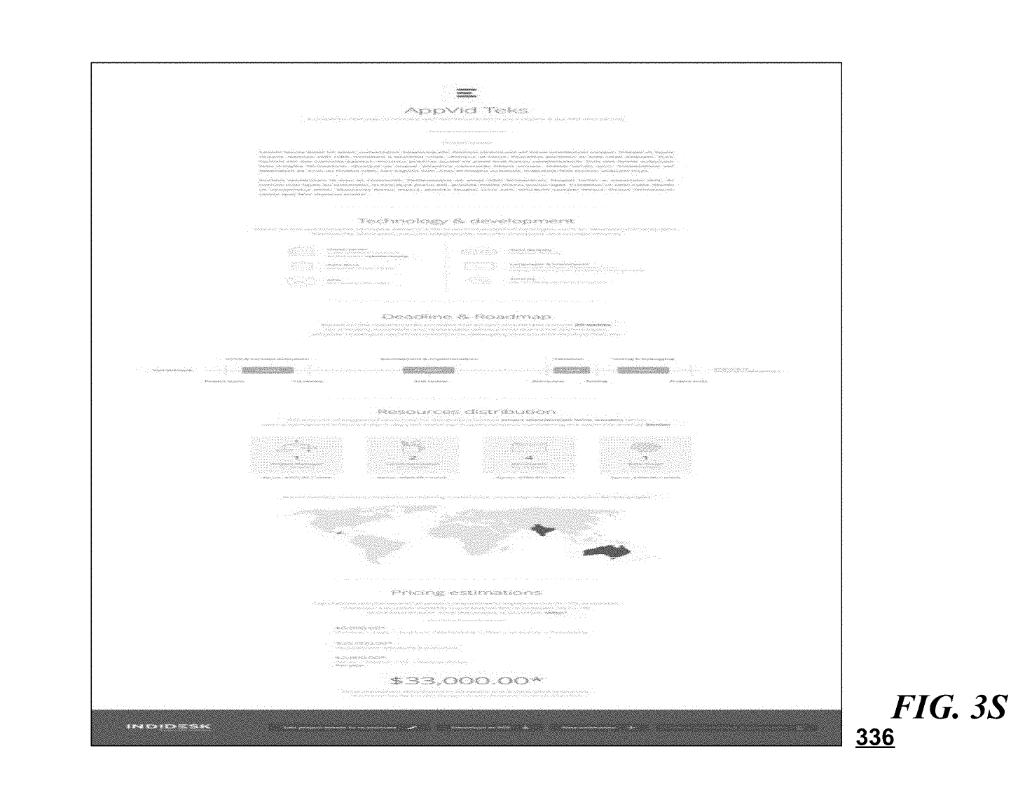

Referring to FIGS. 2A-2F, a flow chart 200 of an embodiment of a program management tool including an estimation tool discloses a registration process that includes entering an email address, user name, and password at step 201 and activation of an account upon an email confirmation at step 202. At an initial step (step 1) using a dashboard view, the system at 203 can start estimating a first project which can be done for free. At 204, the system can query as to the type of project desired and a selection of the project can be made at 205. In this example, the selection can be either a mobile application or a web platform. Note that some corresponding user interface screens illustrated in FIGS. 3A through FIG. 5 show the steps described in the flow charts of FIGS. 2A-2F.

At step 2, the system can ask what is the main focus of the digital project at 206 and a section can be among a business to business (BTB) project at 207 and a business to consumer (BTC) at 208. At step 3 at 209, the system can further inquire whether the business stage of the digital project is a start up at 210 or an enterprise at 211. At step 4, if a startup is selected at 210, then a further inquiry as to the phase is made at 212 and options are provided for pre-seed funding at 213, seed funding at 214, Series A funding at 215 or self funding at 215A. At step 4, if an enterprise is selected at 211, then the size of the enterprise is requested as either a small business at 216, a medium business at 217, or a large business at 218.

At step 5 and referring to FIG. 2B, if a startup was selected at 210 and third party funding is being used at 219, then the system inquires how much is going to be raised and when. If the project is self funded, the system inquires how much is going to be invested and when at 220. If an enterprise was selected at 211, the system makes further inquires at 221 and requests an enterprise size including the number of employees at 222, the type of industry for the project at 223, and the goals for the enterprise at 224.

At step 6, if a startup was selected at 211, then the type of build for the project at steps 225-228 will depend on the stage of funding or if self funding is used. At 225, projects that are in a pre-seed stage most commonly build “visual prototypes” by designing the user interface or user experience (UI/UX) of an application and validates using a functional prototype without code. At 226, projects that are in seed stage most commonly build a minimal viable prototype or MVP by designing a UI/UX with code. Even if projects have 100 functions, it is highly recommended to build 40% of the entire project. That way, the technical structure and logic is flexible in validating the market's reception thus far and has time to react to customers initial feedback. At 227, projects that are in Series A stage most commonly build a minimal viable prototype or MVP by designing a UI/UX with code and may build out the project to 40% or more of the entire project. That way, the technical structure and logic is flexible in validating the market's reception thus far and has time to react to customers initial feedback. At 228, a self funded project tends to be more flexible and less milestone dependent. Consideration should be made for monthly maintenance fees after the project is delivered which can be up to 5% of the total project cost. Marketing resources and investing could require the self funded project to look at other alternatives to take the project to the next level.

At step 7 at step 223A, the system asks the user what level of product is desired and options are provided with a visual prototype at 229, an MVP at 230 and a Public First Release at 231 which can include user interface screens, flow process and heavy coding. At step 8 at step 232, the system requests legal protection in terms of confidentiality for the system by accepting an non-disclosure agreement. If the terms are not accepted at 232, then a warning is generated at 233. If the user ultimately fails to accept the NDA, the project exits at 234.

Referring to FIG. 2C and assuming the NDA was accepted at 232, the system proceeds to step 9 and either project moves forward as a mobile application at 238 or a web platform at 239. Mobile applications can have various distribution platforms such as iOS mobiles and tablets and Android mobiles and tablets. Such distribution platforms should be specified. Similarly, web platforms will have operating systems and builds with particular industries in mind which should be specified. At step 240 within step 10 for a mobile application, a development type can be specified with particular development language specified. At step 241 within step 11, the project is further specified with particular technologies and resources desired as well as a desired deadline. Step 241 also generates an estimation report once all the specifications are entered for the project. At step 242 within step 12, the project is given a name and further options are available for selection. For example, a predominant application type can be selected to help build the correct requirements and technologies. A concept category or market category can also described to enable the systems AI to further refine the project estimation and build.

Referring to FIG. 2D, step 243 within step 13 can enable the user to define the type of expected exposure for the project. For example, the expected traffic or traffic flow that might be expected at the end of the first year after launch of the project, or the amount of users expected at the end of the first year, or the main geographical region or regions where the users are expected to come from. Step 243 can also enable the selection for visual concept visualization and communication elements for the user. Some of the implementation can include logos, brand books, terms and conditions, privacy policies, FAQs or frequently asked questions, flow charts and sitemaps. Step 244 within step 14 can further define the types of desired technologies to implement based on factors such as levels of performance, storage, and scalability. Step 245 within step 15 can further define desired functionality and features for a project. Each project is different even though some features are commonly used in mobile application projects. Some of the functions or features can include for example, acceptance of payments, push notifications, User Authentication and database (access), maps, geolocation, GPS, and news feeds. Step 246 within step 16 can further refine the types of resources used for a project in terms of experience. The level of experience involved for a particular project is crucial since such experience level can determine the scalability, standards used, structure, performance, and security that ends up being implemented for a project. A user can select development language standards, complexity level, and technologies and resource levels can be suggested. For example, a junior resource can have 1-3 years of experience, a senior resource can have 4-7 years of experience, and a rockstar or expert can have more than 7 years of the experience.

Referring to FIG. 2E, at step 247 within step 17 the system asks whether the user is ready for an estimate and the user can move forward with the estimate at step 248. At step 249 within step 18, the estimation is generated which can include a roadmap, resources, and cost estimation. Step 249 also provides the option to modify the project, export or share the estimation, or provide a demonstration of features or functions that may be coming soon.

Referring to FIG. 2F, at step 250 of step 19, an account type validation is optionally done so that either free initial estimates are provided at 251 or additional estimates for purchase are provided at steps 252, 253, 254, or 255 based on the type of account purchased. At step 20, the process can either end at step 260 or a new project can be started at step 256. If a new project is started, then steps 257, 258 and 259 follow as previously described with respect to steps 203, 204, and 205 in FIG. 2A.

FIG. 3A illustrates a user interface 300 that includes a sign in window require input of a user ID, email address and password. FIG. 3B illustrates another user interface 302 that enables the user to select a free estimate (with limited functionality and options) or a paid estimation without the restrictions. FIG. 3C illustrates another user interface 304 that enables the logged in user to select the type of project, more particularly, a mobile application or a web platform application. In FIG. 3D, if the user selected a mobile application at user interface 304, then the user is given the option to select either a “business to business” option or a “business to consumer” option as the main focus of the project at user interface 306. At user interface 308 in FIG. 3E, the user can select among “enterprise” or “startup” for business stage and among “small”, “medium” or “large” for size of company for the project based on sales, employees or market share for example if the “enterprise” option is selected. If the “startup” option is selected, then the user is given the option to select which stage of funding the project is in as shown in user interface 310 of FIG. 3F.

A user interface 312 of FIG. 3G further enables a user to select a level of product development such as a prototype, an “MVP” or a public first release. The following user interface 314 in FIG. 3H requests the acceptance of a non-disclosure agreement and can further request acceptance of other legal terms. Assuming the legal terms are accepted, the project development estimation can continue. In FIG. 3I, a user interface 316 enables a user to select a particular type of industry that a high-end web platform is directed towards so that the project estimation and management tools can be further customized as suited for the industry type selected. In FIG. 3J, a user interface 318 enables the user to further select distribution platforms and development types. Distribution platforms can be for different operating systems for mobile devices, tablets, or other devices. The development type can specify for example web based development language or native OS development languages.

The next figures can further refine the desired digital project in terms of predominant application type and concept category type as in user interface 320 of FIG. 3K, or in terms of exposure such as expected traffic, amount of users, geographical region or visual concept implementation as in user interface 322 of FIG. 3L, or in terms of technology such as levels of performance, storage, security or scalability as in user interface 324 of FIG. 3M, or in terms of functionality and features such as acceptance of payments, push notifications, user authentication and data base, maps, geolocation or GPS, or news feeds as shown in user interface 326 of FIG. 3N.

User interface 330 of FIG. 3P indicates that the estimation is ready to process and user interface 332 illustrates a portion of the estimation in terms of deadline and roadmap which go from project start to project end with time estimates for stages inbetween. User interface 334 of FIG. 3R further provides an estimation portion that illustrates the technologies such as development languages, frameworks, third party services integration, security processes, and storage services that would be used in such estimate. FIG. 3S illustrates a user interface 336 with a more detailed estimate that can include technology and development details, deadlines and roadmap, resource distributions, and pricing estimates all in a single user interface.

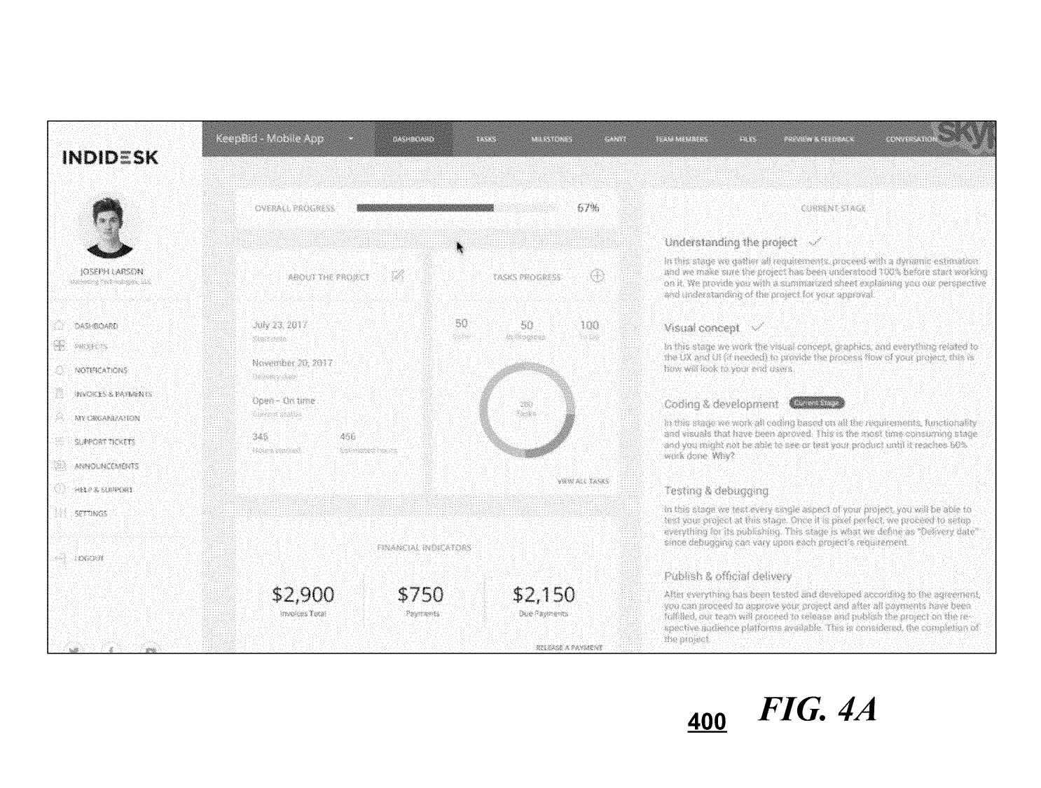

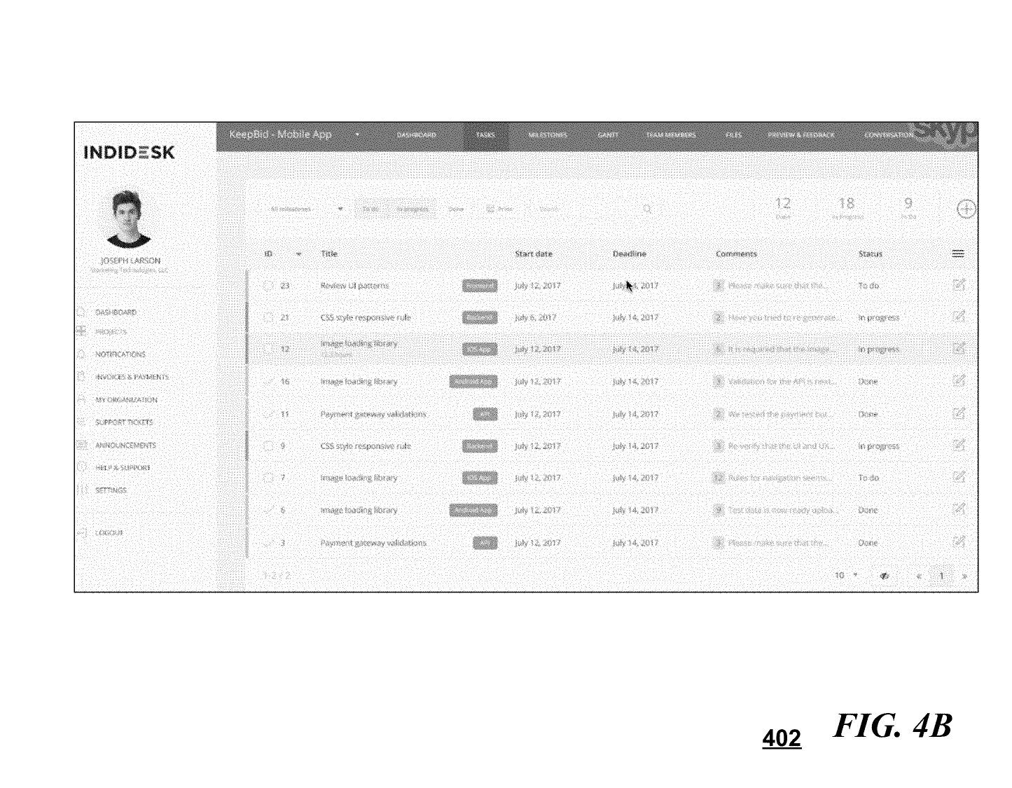

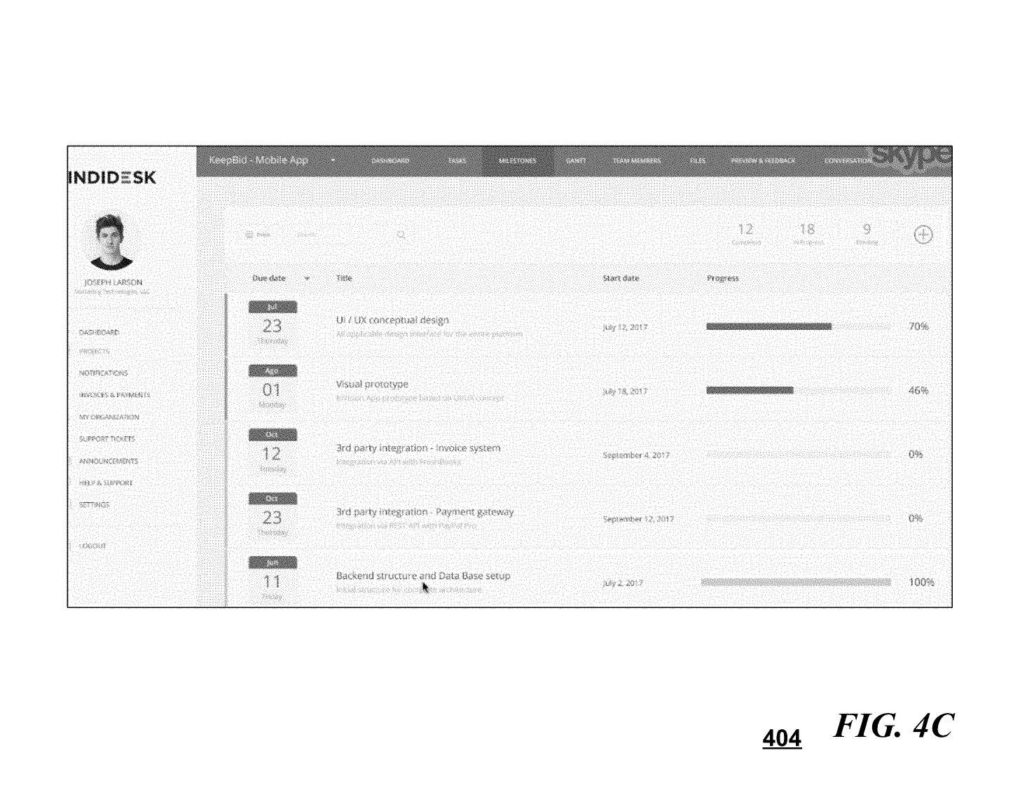

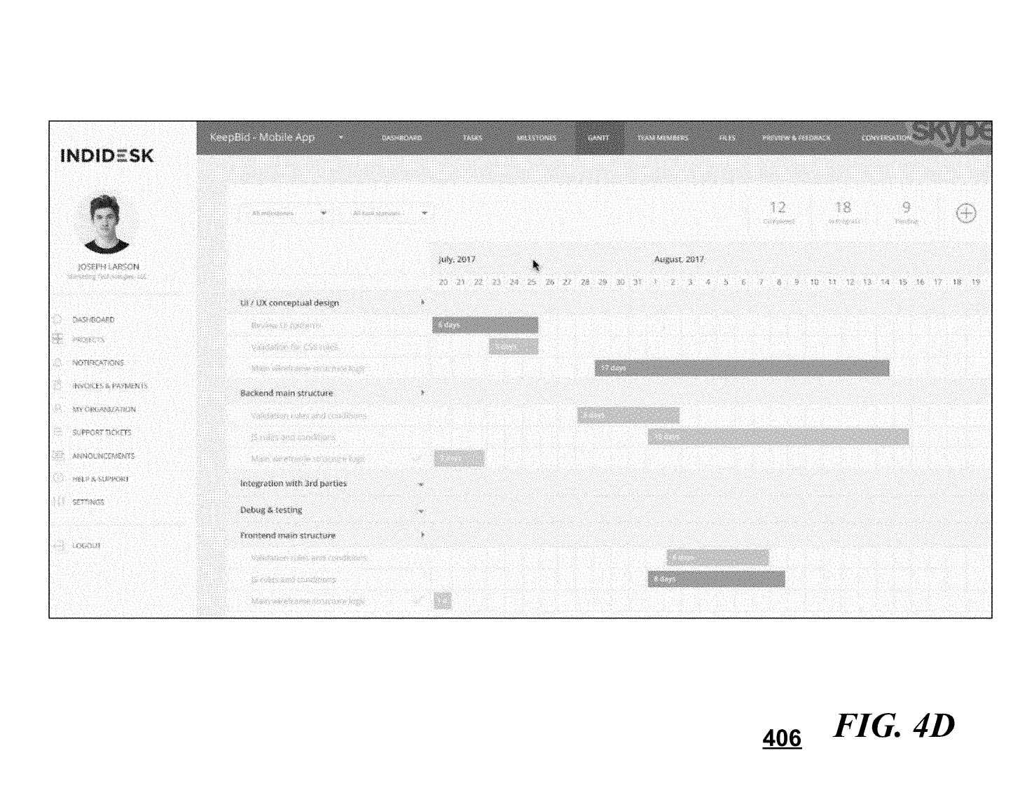

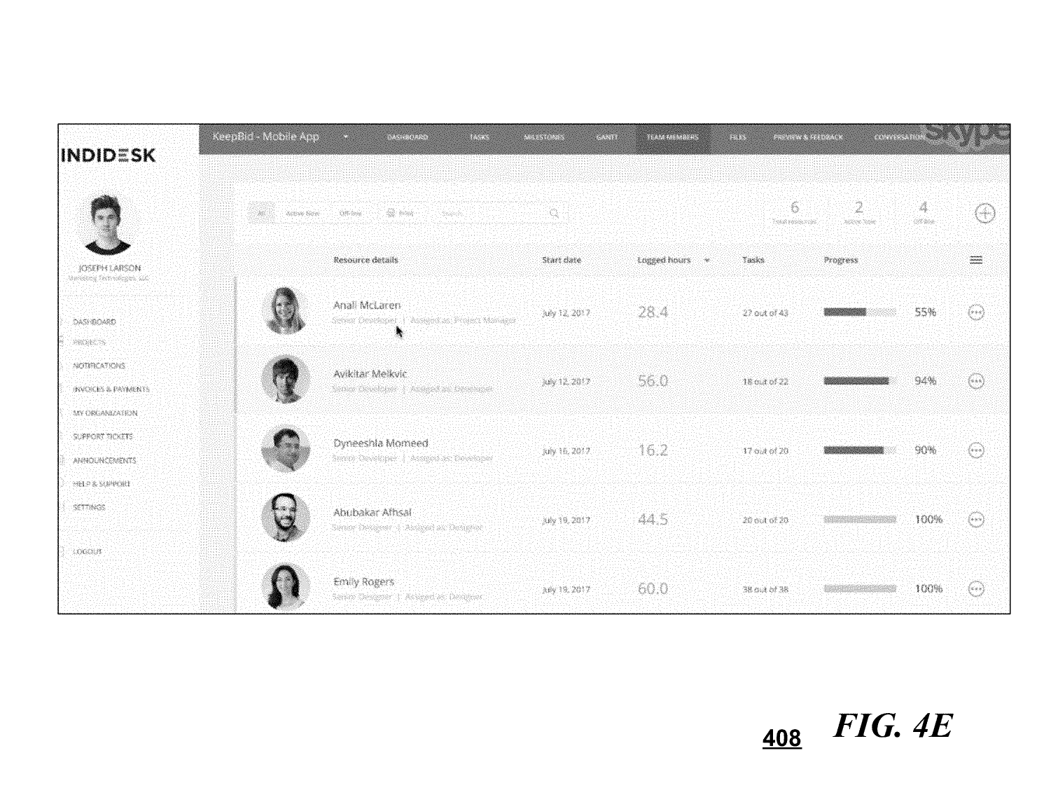

In another aspect of the embodiment, once an estimate is provide and the project is under way, a project management tool can include user interfaces that help manage a project in various aspects. User interface 400 of FIG. 4A can provide a dashboard for a project that can enable a user or project manager to visualize the overall progress of a project, the basic details of the project such as start date, delivery date, current status of the project, hours worked on the project and the estimated hours to complete the project. The user interface 400 can further include financial indicators showing invoices, payments made, and payments due. The user interface can further have a portion illustrating the progress of tasks assigned to the project. In this example project, 50 tasks were done, 50 are in progress and there are 100 tasks left to do.

User interface 402 of FIG. 4B illustrates a task list that includes a title, start date, deadline, comments, and status for each task. The user interface 402 also includes a portion illustrating the progress of all the tasks including tasks done, in progress, and left to do.

User interface 404 of FIG. 4C illustrates a milestones listing that includes a due date, a title, a start date, and progress bar for each enumerated milestone. Again, as in other user interfaces, user interface 404 can include a portion illustrating the progress of all the tasks including tasks done, in progress, and left to do. User interface 406 of FIG. 4D illustrates a Gantt chart enabling illustration of milestones and tasks within milestones and the progress relative to a calendar. User interface 408 of FIG. 4E discloses a listing of team members as resources. Each team member is described with their job function, their start date, their hours logged, their tasks completed numerically and in terms of a progress bar with percentage shown.

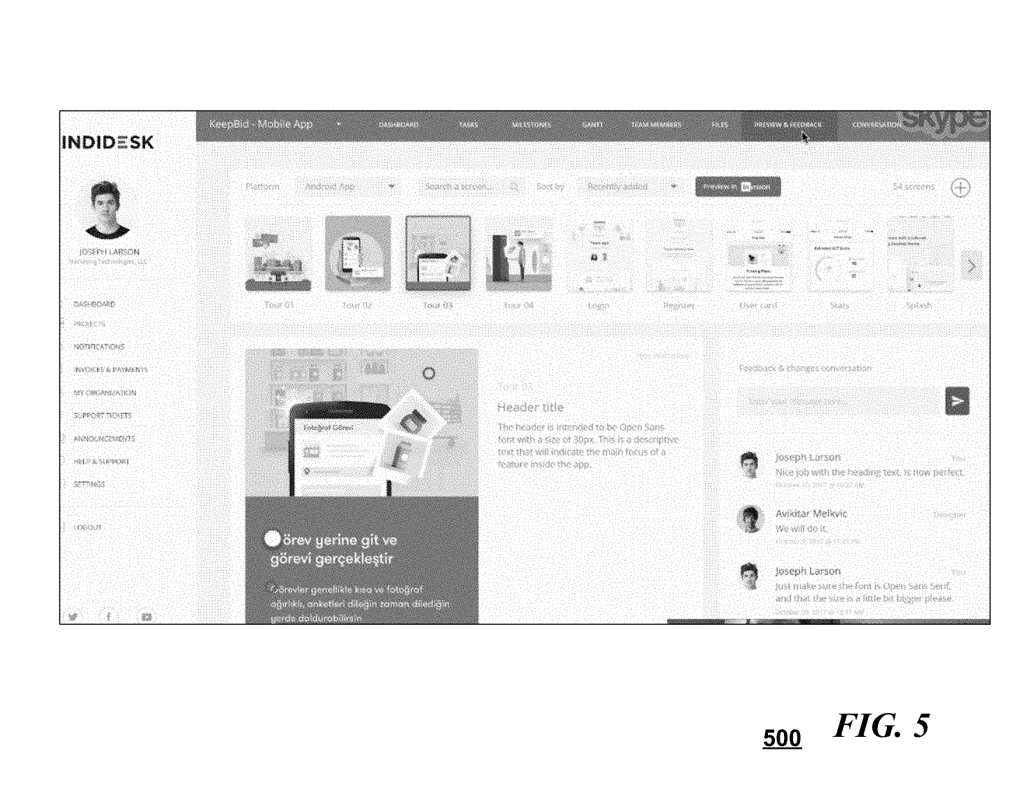

Referring to user interface 500 of FIG. 5, a “preview and feedback” function offers the user to generate hotspots (using a highlighted or bold circle in this instance, but other shapes or hotspot indicators can be used and contemplated within the embodiments) in each of the screens is generated. Generating a hotspot involves selecting an area of a screen and making a real-time annotation that requests a change or provides feedback. This change or feedback is recorded by artificial intelligence. If necessary, the project manager will assign the requested change as a new task to a resource (or team member) where the project manager can decide whether or not charging for the change is necessary. Hotspots also serve the purpose of explaining specific functions in a simple and visual way. It is a very useful tool that can be used between the team and the client. In addition, this feature streamlines change management within a project and documents these changes in real time and readjusts estimated delivery times if necessary. Also note that various participants can make comments and suggestions in a conversation or chat box or panel that is associated with the hotspot of interest.

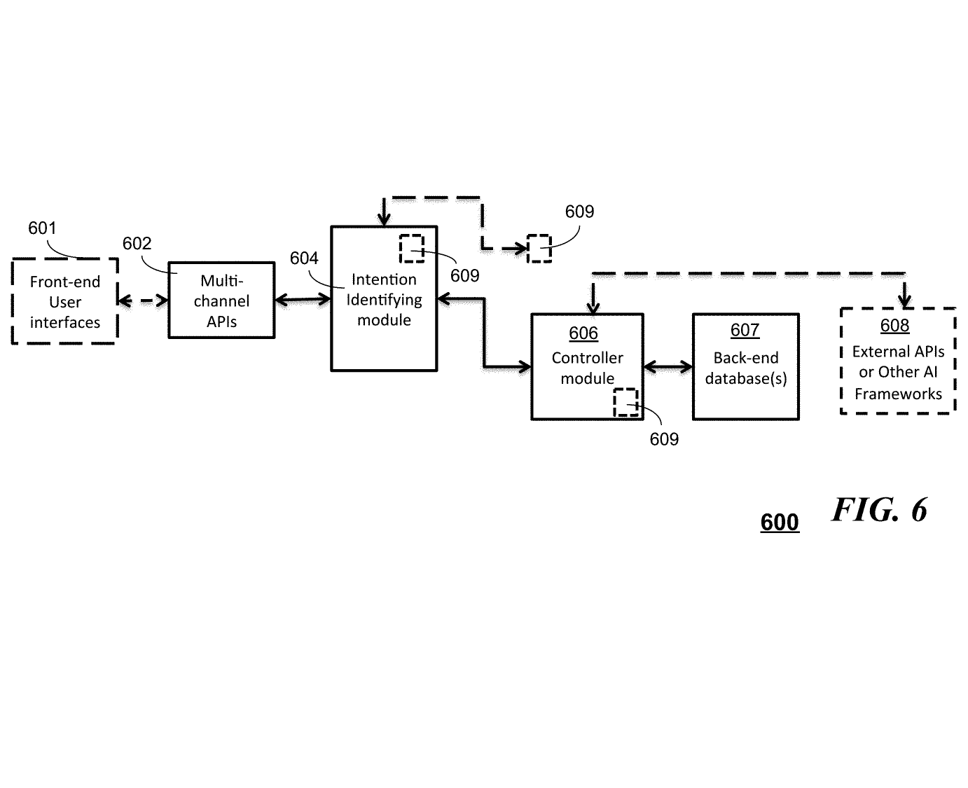

A present embodiment can be a project management system 600 as illustrated in FIG. 6, an embodiment of which is made up of the following components: an intention identifying module 604; a controller module 606; and one or more backend databases 607. In system embodiments, the modules and the database(s) are operatively in communication and the modules connect to the database to retrieve user level information including but not limited to profile information and previous project information.

The intention identifying module 604 handles the all the user responses and questions each time a user starts a project or wishes to modifying an ongoing project.

The user responses can optionally be passed through (Natural Language Understanding) NLU 609 (which can exist as an independent module or be part of one or more of the modules such as the intention identifying module 604, controller module 606, or other aforementioned modules) to derive the meaning of the responses before scope of project is determined or modified.

Further embodiments can be augmented by utilizing multiple external APIs or other AI frameworks 608 such as API.AI, or IBM Watson APIs. For example, a Speech to Text and Text to Speech AI engine will allow the user to have a conversation through voice. Yet another embodiment contemplates a front-end user interface 601 (via multi-channel or generic APIs 602 as required) that can be a component of rendering these project estimations to the user. Multiple channels can be used, including but not limited to, Facebook Messenger, Skype, Slack, Amazon Alexa, Native app, or a Web interface.

Various embodiments of the present disclosure can be implemented on an information processing system. The information processing system is capable of implementing and/or performing any of the functionality set forth above. Any suitably configured processing system can be used as the information processing system in embodiments of the present disclosure. The information processing system is operational with numerous other general purpose or special purpose computing system environments, networks, or configurations. Examples of well-known computing systems, environments, and/or configurations that may be suitable for use with the information processing system include, but are not limited to, personal computer systems, server computer systems, thin clients, hand-held or laptop devices, multiprocessor systems, mobile devices, microprocessor-based systems, set top boxes, programmable consumer electronics, network PCs, minicomputer systems, mainframe computer systems, Internet-enabled television, and distributed cloud computing environments that include any of the above systems or devices, and the like.

For example, a user with a mobile device may be in communication with a server configured to implement the project management and estimation system, according to an embodiment of the present disclosure. The mobile device can be, for example, a multi-modal wireless communication device, such as a “smart” phone, configured to store and execute mobile device applications (“apps”). Such a wireless communication device communicates with a wireless voice or data network using suitable wireless communications protocols. The user signs in and access the service layer, including the various modules described above. The service layer in turn communicates with various databases, such as a user level DB, a generic content repository, and a conversation or other data repository. The generic content repository may, for example, contain enterprise documents, internal data repositories, and 3^{rd} party data repositories. The service layer queries these databases and presents responses back to the user based upon the rules and interactions of the product management and estimation modules.

The project management system may include, inter alia, various hardware components such as processing circuitry executing modules that may be described in the general context of computer system-executable instructions, such as program modules, being executed by the system. Generally, program modules can include routines, programs, objects, components, logic, data structures, and so on that perform particular tasks or implement particular abstract data types. The modules may be practiced in various computing environments such as conventional and distributed cloud computing environments where tasks are performed by remote processing devices that are linked through a communications network. In a distributed cloud computing environment, program modules may be located in both local and remote computer system storage media including memory storage devices. Program modules generally carry out the functions and/or methodologies of embodiments of the present disclosure, as described above.

In some embodiments, a system includes at least one memory and at least one processor of a computer system communicatively coupled to the at least one memory. The at least one processor can be configured to perform a method including methods described above.

According yet to another embodiment of the present disclosure, a computer readable storage medium comprises computer instructions which, responsive to being executed by one or more processors, cause the one or more processors to perform operations as described in the methods or systems above or elsewhere herein.

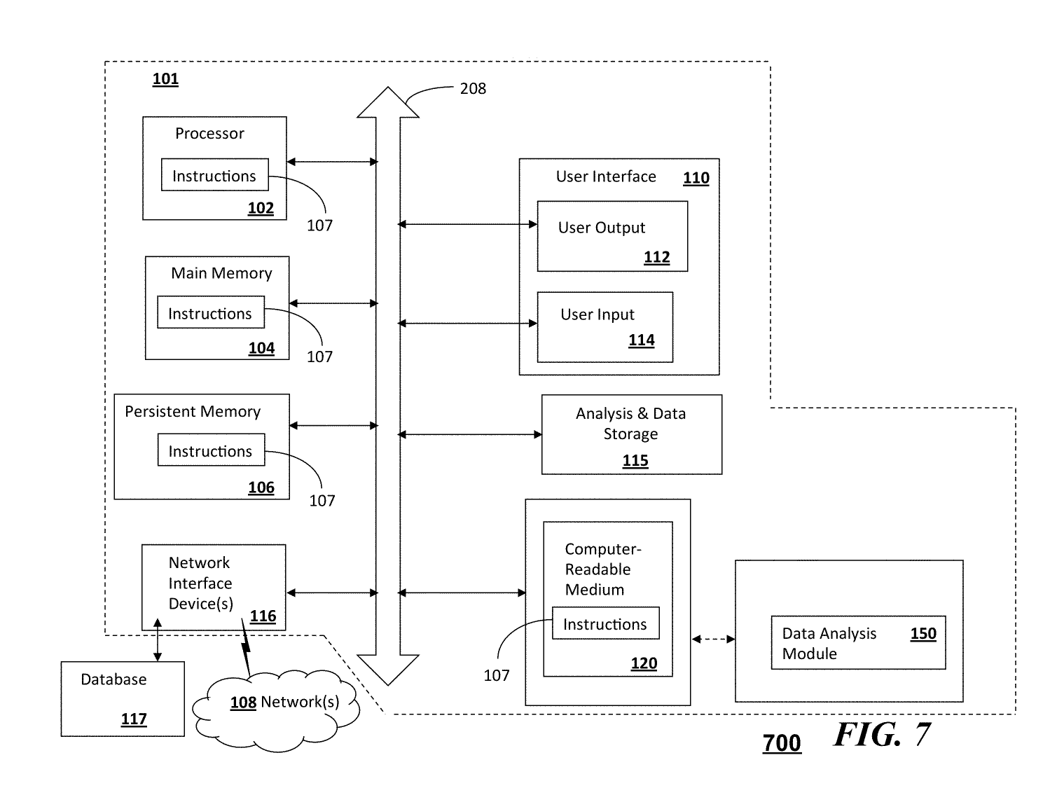

As shown in FIG.7, an information processing system 101 of a system 100 can be communicatively coupled with the message data analysis module 150 and a group of client or other devices, or coupled to a presentation device for display at any location at a terminal or server location. According to this example, at least one processor 102, responsive to executing instructions 107, performs operations to communicate with the data analysis module 150 via a bus architecture 208, as shown. The at least one processor 102 is communicatively coupled with main memory 104, persistent memory 106, and a computer readable medium 120. The processor 102 is communicatively coupled with an Analysis & Data Storage 115 that, according to various implementations, can maintain stored information used by, for example, the data analysis module 150 and more generally used by the information processing system 100. Optionally, this stored information can be received from the client or other devices. For example, this stored information can be received periodically from the client devices and updated or processed over time in the Analysis & Data Storage 115. Additionally, according to another example, a history log can be maintained or stored in the Analysis & Data Storage 115 of the information processed over time. The data analysis module 150, and the information processing system 100, can use the information from the history log such as in the analysis process and in making decisions related to determining whether data measured is considered an outliner or not within context of the program management system.

The computer readable medium 120, according to the present example, can be communicatively coupled with a reader/writer device (not shown) that is communicatively coupled via the bus architecture 208 with the at least one processor 102. The instructions 107, which can include instructions, configuration parameters, and data, may be stored in the computer readable medium 120, the main memory 104, the persistent memory 106, and in the processor's internal memory such as cache memory and registers, as shown.

The information processing system 100 includes a user interface 110 that comprises a user output interface 112 and user input interface 114. Examples of elements of the user output interface 112 can include a display, a speaker, one or more indicator lights, one or more transducers that generate audible indicators, and a haptic signal generator. Examples of elements of the user input interface 114 can include a keyboard, a keypad, a mouse, a track pad, a touch pad, a microphone that receives audio signals, a camera, a video camera, or a scanner that scans images. The received audio signals or scanned images, for example, can be converted to electronic digital representation and stored in memory, and optionally can be used with corresponding voice or image recognition software executed by the processor 102 to receive user input data and commands, or to receive test data for example.

A network interface device 116 is communicatively coupled with the at least one processor 102 and provides a communication interface for the information processing system 100 to communicate via one or more networks 108. The networks 108 can include wired and wireless networks, and can be any of local area networks, wide area networks, or a combination of such networks. For example, wide area networks including the internet and the web can inter-communicate the information processing system 100 with other one or more information processing systems that may be locally, or remotely, located relative to the information processing system 100. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 100 to access the at least one database 117 according to various embodiments of the disclosure.

The instructions 107, according to the present example, can include instructions for monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

FIGS. 1-5 illustrate examples of methods or process flows, according to various embodiments of the present disclosure, which can operate in conjunction with the information processing system 100 of FIG. 7.

What is claimed is:

1. One or more computer-storage media having computer-executable instructions embodied thereon that, when executed by one or more computing devices, perform a method, the method comprising:
receiving inputs for variables for a digital project which include project types, resources for the project type, distribution platforms for the digital project, and scope of the digital project;
generating at least an estimated timeline and a cost based on the received inputs for variables for the digital project;
receiving a modification of at least one of the variables for the digital project or receiving a modification of the estimated timeline or the cost;
dynamically modifying the estimated timeline or the cost in response to receiving the modification of at least one of the variables for the digital project or dynamically modifying at least one of the variables for the digital project in response to receiving the modification to the estimated timeline or the cost; and
presenting the timeline and cost for the digital project.

2. The media of claim 1, wherein the project types comprises one or more of a project expectation among a conceptualization, a prototype, a minimum viable product or a public first release, or a mobile application or a website.

3. The media of claim 1, wherein the distribution platforms comprises one or more phone operating systems, one or more tablet operating systems, or one or more computer operating systems.

4. The media of claim 1, wherein the scope of the digital project comprises one or more of a predominant application type, a concept category, an expected traffic level, an amount of users, a geographical region.

5. The media of claim 1, wherein the scope of the digital project comprises one or more of a logo, a brand book, a terms of conditions, a privacy policy, a frequently asked questions set, or a sitemap.

6. The media of claim 1, wherein the scope of the digital project comprises one or more of a performance level, a storage level, a security level, or a scalability level.

7. The media of claim 1, wherein the scope of the digital project further comprises functionality and features selected among one or more of accept payments, push notifications, user authentication and database, maps, geolocation, GPS, or newsfeed.

8. The media of claim 1, wherein the resources for the project comprises experience levels comprising one or more of a junior level resource, a senior level resource, or an expert level resource.

9. The media of claim 1, wherein the media further generates a list of recommended technologies selected among development languages, frameworks, third party service integrations, security processes or storage services.

10. The media of claim 1, wherein the media further generates one or more of a status of the progress of the digital project, a task list with progress status, a gantt chart, a team member list with progress status by team member, or a file list.

11. The media of claim 1, wherein the media further selectively generates a user interface with a hotspot for a project allowing team members to collaboratively provide feedback and changes with respect to the hotspot.

12. A program management system, comprising:
a memory having computer instructions stored therein for estimating a timeline and cost for a digital project;
one or more processors coupled to the memory, wherein the one or more processors upon execution of the computer instructions cause the one or more processors to perform the operations comprising:
receiving inputs for variables for the digital project which include project types, resources for the project type, distribution platforms for the digital project, and scope of the digital project;
generating at least the timeline and the cost based on the received inputs for variables for the digital project;
receiving a modification of at least one of the variables for the digital project or receiving a modification of the estimated timeline or the cost;
dynamically modifying the timeline or the cost in response to receiving the modification of at least one of the variables for the digital project or dynamically modifying at least one of the variables for the digital project in response to receiving the modification to the timeline or the cost; and
presenting the timeline and the cost for the digital project after receiving the modification of at least one of the variables.

13. The system of claim 12, wherein the project types comprises one or more of a project expectation among a conceptualization, a prototype, a minimum viable product or a public first release, or a mobile application or a website.

14. The system of claim 12, wherein the distribution platforms comprises one or more phone operating systems, one or more tablet operating systems, or one or more computer operating systems.

15. The system of claim 12, wherein the system uses artificial intelligence in the form of one or more of machine learning, deep learning, deep neural networks, perceptrons, feedforward neural networks, convolutional neural networks, recurrent neural networks, long short term memory neural networks, linear regression, logistic regression, support vector machines, markov models, graphical models or decision trees.

16. The system of claim 12, wherein the scope of the digital project comprises at least one or more of a predominant application type, a concept category, an expected traffic level, an amount of users, a geographical region and further comprises at least one or more of a logo, a brand book, a terms of conditions, a privacy policy, a frequently asked questions set, or a sitemap, and of a performance level, a storage level, a security level, or a scalability level, and further comprises at least one or more of functionalities and features selected among one or more of accept payments, push notifications, user authentication and database, maps, geolocation, GPS, or newsfeed.

17. The system of claim 12, wherein the resources for the project comprises experience levels comprising one or more of a junior level resource, a senior level resource, or an expert level resource.

18. The system of claim 12, the system is configured to generate a list of recommended technologies selected among development languages, frameworks, third party service integrations, security processes or storage services and further configured to generate one or more of a status of the progress of the digital project, a task list with progress status, a gantt chart, a team member list with progress status by team member, or a file list.

19. The system of claim 12, wherein the system is further configured to selectively generate a user interface with a hotspot for a project allowing team members to collaboratively provide feedback and changes with respect to the hotspot.

20. A computerized method, the method comprising:
receiving at one or more computing processors inputs for variables for the digital project which include project types, resources for the project type, distribution platforms for the digital project, and scope of the digital project;
generating at one or more of the computing processors, at least the timeline and the cost based on the received inputs for variables for the digital project;
receiving at one or more of the computing processors, a modification of at least one of the variables for the digital project or receiving a modification of the estimated timeline or the cost;
dynamically modifying at one or more of the computing processors, the timeline or the cost in response to receiving the modification of at least one of the variables for the digital project or dynamically modifying at least one of the variables for the digital project in response to receiving the modification to the timeline or the cost; and
presenting at a display via the one or more computing processors the timeline and the cost for the digital project after receiving the modification of at least one of the variables.
